(19) United States
(12) Patent Application Publication
(10) Pub. No.: US 2026/0172171 A1
(43) Pub. Date: Jun. 18, 2026

(54) CONFIGURATIONS FOR DATA-CARRYING REFERENCE SIGNALS

(71) Applicant: QUALCOMM Incorporated, San Diego, CA (US)

(72) Inventors: Chih-Hao LIU, San Diego, CA (US); Jing SUN, San Diego, CA (US); Morteza SOLTANI, San Diego, CA (US); Jing JIANG, San Diego, CA (US)

(21) Appl. No.: 18/984,455

(22) Filed: Dec. 17, 2024

(51) Int. Cl. H04L 5/00; H04W 72/1263; H04W 72/232

(52) U.S. Cl. CPC H04L 5/0048; H04W 72/1263; H04W 72/232

(57) ABSTRACT

Methods, systems, and devices for wireless communications are described. A wireless communications device may communicate data-carrying reference signals (DC-RS) according to a configuration, and the DC-RS may be used for covariance matrix estimation. For example, a user equipment (UE) may receive a configuration message configuring the DC-RS that may be included in a PUSCH or PDSCH transmission. The configuration message may indicate that the DC-RSs may be communicated via a subset of REs of a shared data channel, and that the DC-RSs may be configured to encode data allocated to the shared channel. The configuration may specify a modulation coding scheme (MCS) to use in communicating the DC-RS, a quantity of layers, a subset of ports, a pattern of REs, among other parameters. In response to receiving the configuration, the UE may communicate data with the network entity based on the configuration.

### TECHNICAL FIELD

The following relates to wireless communications, including configurations for data-carrying reference signals (DC-RSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communication devices may be configured with time-domain resource allocations for various transmissions (e.g., physical uplink shared channel (PUSCH) transmissions or physical downlink shared channel transmissions) that cross slot boundaries. These configurations may be referred to as “fluid” start and length indicator value (SLIV) (fluid SLIV) designs.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code to cause the UE to receive control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicate the data allocated to the shared data channel via the set of multiple resource elements of the shared data channel, the data including the first portion encoded in the set of multiple data-carrying reference signals and a second portion encoded in a second subset of resource elements of the set of multiple resource elements.

Another UE for wireless communications is described. The UE may include means for receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

A non-transitory computer-readable medium storing code for wireless communications is described. The code may include instructions executable by one or more processors (e.g., directly, indirectly, after pre-processing, without pre-processing) to receive control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicate the data allocated to the shared data channel via the set of multiple resource elements of the shared data channel, the data including the first portion encoded in the set of multiple data-carrying reference signals and a second portion encoded in a second subset of resource elements of the set of multiple resource elements.

In some examples of the method, UEs, and non-transitory computer-readable medium described herein, the control signaling may be indicative of a layer quantity backoff value for communication of the set of multiple data-carrying reference signals and the set of multiple data-carrying reference signals may be communicated via the first subset of resource elements using a second quantity of layers that may be based on the layer quantity backoff value and a first quantity of layers configured for communication of the shared data channel.

In some examples of the method, UEs, and non-transitory computer-readable medium described herein, receiving the control signaling may include operations, features, means, or instructions for receiving radio resource control signaling that may be indicative of the layer quantity backoff value.

In some examples of the method, UEs, and non-transitory computer-readable medium described herein, receiving the control signaling may include operations, features, means, or instructions for receiving downlink control information that may be indicative of the layer quantity backoff value and that schedules communication of the shared data channel.

In some examples of the method, UEs, and non-transitory computer-readable medium described herein, the control signaling may be indicative of a modulation order backoff value for communication of the set of multiple data-carrying reference signals and the set of multiple data-carrying reference signals may be communicated via the first subset of resource elements and encoded using a second modulator order that may be based on the modulation order backoff value and a first modulation order configured for communication of the shared data channel.

In some examples of the method, UEs, and non-transitory computer-readable medium described herein, receiving the control signaling may include operations, features, means, or instructions for receiving radio resource control signaling that may be indicative of the modulation order backoff value.

In some examples of the method, UEs, and non-transitory computer-readable medium described herein, receiving the control signaling may include operations, features, means, or instructions for receiving downlink control information that may be indicative of the modulation order backoff value and that schedules communication of the shared data channel.

In some examples of the method, UEs, and non-transitory computer-readable medium described herein, the modulation order backoff value may be applied to a first covariance matrix estimation window and a second covariance matrix estimation window.

In some examples of the method, UEs, and non-transitory computer-readable medium described herein, the downlink control information indicates the modulation order backoff value that may be a first modulation order backoff value to be applied for a first covariance matrix estimation window and the downlink control information indicates a second modulation order backoff value to be applied for a second covariance matrix estimation window.

In some examples of the method, UEs, and non-transitory computer-readable medium described herein, receiving the control signaling may include operations, features, means, or instructions for receiving radio resource control signaling including a set of modulation order backoff values and receiving downlink control information indicative of the modulation order backoff value from the set of modulation order backoff values.

In some examples of the method, UEs, and non-transitory computer-readable medium described herein, the control signaling may be indicative of a subset of ports of a set of multiple ports to use for transmission of the set of multiple data-carrying reference signals and the set of multiple data-carrying reference signals may be communicated via the subset of ports that may be different from one or more ports used for communication of the shared data channel.

In some examples of the method, UEs, and non-transitory computer-readable medium described herein, receiving the control signaling may include operations, features, means, or instructions for receiving downlink control information message that may be indicative of the subset of ports.

In some examples of the method, UEs, and non-transitory computer-readable medium described herein, receiving the control signaling may include operations, features, means, or instructions for receiving a bitmap indicative of the subset of ports, where each value of the bitmap may be associated with a respective demodulation reference signal (DMRS) port configured for communication of the shared data channel.

In some examples of the method, UEs, and non-transitory computer-readable medium described herein, receiving the control signaling may include operations, features, means, or instructions for receiving an indication of a subset of demodulation reference signal ports to use for communication of the shared data channel and where the subset of ports to use for communication of the set of multiple data-carrying reference signals corresponds to the subset of demodulation reference signal ports.

In some examples of the method, UEs, and non-transitory computer-readable medium described herein, receiving the control signaling may include operations, features, means, or instructions for receiving an indication of an index that may be mapped to the subset of ports via a table that maps a set of multiple indexes to respective subsets of ports.

In some examples of the method, UEs, and non-transitory computer-readable medium described herein, the control signaling may be indicative of a pattern of the first subset of resource elements within the set of multiple resource elements allocated for communication of the shared data channel.

In some examples of the method, UEs, and non-transitory computer-readable medium described herein, the pattern may be indicated via a cell identifier associated with a tone offset, a symbol offset, a random tone offset at different symbols, or a combination thereof.

In some examples of the method, UEs, and non-transitory computer-readable medium described herein, the control signaling may be indicative of a respective configuration per covariance matrix estimation window of two or more covariance matrix estimation windows.

In some examples of the method, UEs, and non-transitory computer-readable medium described herein, the configuration further specifies a first modulation order used for encoding the set of multiple data-carrying reference signals, the first modulation order being a same modulation order as a second modulation order used for encoding data of the shared data channel separate from the set of multiple data-carrying reference signals or being a smaller modulation order than the second modulation order.

In some examples of the method, UEs, and non-transitory computer-readable medium described herein, the configuration further specifies a first quantity of layers to be used for communication of the set of multiple data-carrying reference signals, the first quantity of layers being equal to or less than a second quantity of layers used for communication of the shared data channel separate from the set of multiple data-carrying reference signals.

In some examples of the method, UEs, and non-transitory computer-readable medium described herein, the configuration further specifies a set of multiple ports associated with the set of multiple data-carrying reference signals, the set of multiple ports being at least partially located at a location of a set of multiple ports associated with demodulated reference signals of the shared data channel and communicating the data may be based on the set of multiple ports.

Some examples of the method, UEs, and non-transitory computer-readable medium described herein may further include operations, features, means, or instructions for determining a transport block size for the shared data channel based on a quantity of resource elements of the set of multiple resource elements and a modulation order scheduled for communication of the shared data channel.

Some examples of the method, UEs, and non-transitory computer-readable medium described herein may further include operations, features, means, or instructions for determining a transport block size for the shared data channel based on a first quantity of resource elements in the second subset and a first modulation order used for encoding the shared data channel and a second quantity of resource elements in the first subset and a second modulation order used for encoding the set of multiple data-carrying reference signals.

A method for wireless communications by a network entity is described. The method may include outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code to cause the network entity to output control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicate the data allocated to the shared data channel via the set of multiple resource elements of the shared data channel, the data including the first portion encoded in the set of multiple data-carrying reference signals and a second portion encoded in a second subset of resource elements of the set of multiple resource elements.

Another network entity for wireless communications is described. The network entity may include means for outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

A non-transitory computer-readable medium storing code for wireless communications is described. The code may include instructions executable by one or more processors (e.g., directly, indirectly, after pre-processing, without pre-processing) to output control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel and communicate the data allocated to the shared data channel via the set of multiple resource elements of the shared data channel, the data including the first portion encoded in the set of multiple data-carrying reference signals and a second portion encoded in a second subset of resource elements of the set of multiple resource elements.

In some examples of the method, network entities, and non-transitory computer-readable medium described herein, the control signaling may be indicative of a layer quantity backoff value for communication of the set of multiple data-carrying reference signals and the set of multiple data-carrying reference signals may be communicated via the first subset of resource elements using a second quantity of layers that may be based on the layer quantity backoff value and a first quantity of layers configured for communication of the shared data channel.

In some examples of the method, network entities, and non-transitory computer-readable medium described herein, outputting the control signaling may include operations, features, means, or instructions for outputting radio resource control signaling that may be indicative of the layer quantity backoff value.

In some examples of the method, network entities, and non-transitory computer-readable medium described herein, outputting the control signaling may include operations, features, means, or instructions for outputting downlink control information that may be indicative of the layer quantity backoff value and that schedules communication of the shared data channel.

In some examples of the method, network entities, and non-transitory computer-readable medium described herein, the control signaling may be indicative of a modulation order backoff value for communication of the set of multiple data-carrying reference signals and the set of multiple data-carrying reference signals may be communicated via the first subset of resource elements and encoded using a second modulator order that may be based on the modulation order backoff value and a first modulation order configured for communication of the shared data channel.

In some examples of the method, network entities, and non-transitory computer-readable medium described herein, outputting the control signaling may include operations, features, means, or instructions for outputting radio resource control signaling that may be indicative of the modulation order backoff value.

In some examples of the method, network entities, and non-transitory computer-readable medium described herein, outputting the control signaling may include operations, features, means, or instructions for outputting downlink control information that may be indicative of the modulation order backoff value and that schedules communication of the shared data channel.

In some examples of the method, network entities, and non-transitory computer-readable medium described herein, the modulation order backoff value may be applied to a first covariance matrix estimation window and a second covariance matrix estimation window.

In some examples of the method, network entities, and non-transitory computer-readable medium described herein, the downlink control information indicates the modulation order backoff value that may be a first modulation order backoff value to be applied for a first covariance matrix estimation window and the downlink control information indicates a second modulation order backoff value to be applied for a second covariance matrix estimation window.

In some examples of the method, network entities, and non-transitory computer-readable medium described herein, outputting mitting the control signaling may include operations, features, means, or instructions for outputting radio resource control signaling including a set of modulation order backoff values and outputting downlink control information indicative of the modulation order backoff value from the set of modulation order backoff values.

In some examples of the method, network entities, and non-transitory computer-readable medium described herein, the control signaling may be indicative of a subset of ports of a set of multiple ports to use for communication of the set of multiple data-carrying reference signals and the set of multiple data-carrying reference signals may be communicated via the subset of ports that may be different from one or more ports used for communication of the shared data channel.

In some examples of the method, network entities, and non-transitory computer-readable medium described herein, outputting the control signaling may include operations, features, means, or instructions for outputting downlink control information message that may be indicative of the subset of ports.

In some examples of the method, network entities, and non-transitory computer-readable medium described herein, outputting the control signaling may include operations, features, means, or instructions for outputting a bitmap indicative of the subset of ports, where each value of the bitmap may be associated with a respective DMRS port configured for communication of the shared data channel.

In some examples of the method, network entities, and non-transitory computer-readable medium described herein, outputting the control signaling may include operations, features, means, or instructions for outputting an indication of a subset of demodulation reference signal ports to use for communication of the shared data channel and where the subset of ports to use for communication of the set of multiple data-carrying reference signals corresponds to the subset of demodulation reference signal ports.

In some examples of the method, network entities, and non-transitory computer-readable medium described herein, outputting the control signaling may include operations, features, means, or instructions for outputting an indication of an index that may be mapped to the subset of ports via a table that maps a set of multiple indexes to respective subsets of ports.

In some examples of the method, network entities, and non-transitory computer-readable medium described herein, the control signaling may be indicative of a pattern of the first subset of resource elements within the set of multiple resource elements allocated for communication of the shared data channel.

In some examples of the method, network entities, and non-transitory computer-readable medium described herein, the pattern may be indicated via a cell identifier associated with a tone offset, a symbol offset, a random tone offset at different symbols, or a combination thereof.

In some examples of the method, network entities, and non-transitory computer-readable medium described herein, the control signaling may be indicative of a respective configuration per covariance matrix estimation window of two or more covariance matrix estimation windows.

In some examples of the method, network entities, and non-transitory computer-readable medium described herein, the configuration further specifies a first modulation order used for encoding the set of multiple data-carrying reference signals, the first modulation order being a same modulation order as a second modulation order used for encoding data of the shared data channel separate from the set of multiple data-carrying reference signals or being a smaller modulation order than the second modulation order.

In some examples of the method, network entities, and non-transitory computer-readable medium described herein, the configuration further specifies a first quantity of layers to be used for communication of the set of multiple data-carrying reference signals, the first quantity of layers being equal to or less than a second quantity of layers used for communication of the shared data channel separate from the set of multiple data-carrying reference signals.

In some examples of the method, network entities, and non-transitory computer-readable medium described herein, the configuration further specifies a set of multiple ports associated with the set of multiple data-carrying reference signals, the set of multiple ports being at least partially located at a location of a set of multiple ports associated with demodulated reference signals of the shared data channel and communicating the data may be based on the set of multiple ports.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support configurations for data-carrying reference signals (DC-RSs) in accordance with one or more aspects of the present disclosure.

FIG. 3 shows examples of DC-RS patterns that support configurations for DC-RSs in accordance with one or more aspects of the present disclosure.

FIG. 4 shows an example of a process flow that supports configurations for DC-RSs in accordance with one or more aspects of the present disclosure.

FIGS. 5 and 6 show block diagrams of devices that support configurations for DC-RSs in accordance with one or more aspects of the present disclosure.

FIG. 7 shows a block diagram of a communications manager that supports configurations for DC-RSs in accordance with one or more aspects of the present disclosure.

FIG. 8 shows a diagram of a system including a device that supports configurations for DC-RSs in accordance with one or more aspects of the present disclosure.

FIGS. 9 and 10 show block diagrams of devices that support configurations for DC-RSs in accordance with one or more aspects of the present disclosure.

FIG. 11 shows a block diagram of a communications manager that supports configurations for DC-RSs in accordance with one or more aspects of the present disclosure.

FIG. 12 shows a diagram of a system including a device that supports configurations for DC-RSs in accordance with one or more aspects of the present disclosure.

FIGS. 13 and 14 show flowcharts illustrating methods that support configurations for DC-RSs in accordance with one or more aspects of the present disclosure.

### DETAILED DESCRIPTION

Some wireless communication devices may be configured with time-domain resource allocations for various transmissions (e.g., physical uplink shared channel (PUSCH) transmissions or physical downlink shared channel transmissions) that cross slot boundaries. These configurations may be referred to as “fluid” start and length indicator value (SLIV) (fluid SLIV) designs. As a result of these configurations, and in order to reduce the demodulation reference signal (DMRS) overhead, the DMRS may be transmitted uniformly across the allocation, which may result in reduced DMRS transmissions relative to typical allocations. The reduction in DMRS transmissions may result in receiver devices being unable to perform efficient and accurate channel estimation operations (e.g., to estimate channel interference). Additional periodic reference signals may be introduced in resource elements (REs) for channel estimation, or null REs may be introduced to avoid collisions between different cells. However, such techniques may impact data throughput, as reference signals or null REs may utilize resources (e.g., REs) typically used for data transmissions.

To increase effectiveness of channel estimation techniques used in determining channel interference, a wireless communications device may communicate data-carrying reference signals (DC-RSs) according to a configuration, and the DC-RS may be used for covariance matrix estimation (e.g., channel estimation). For example, a user equipment (UE) may receive (e.g., from a network entity) a configuration message configuring the DC-RS that may be included in a PUSCH or PDSCH transmission. The configuration message may indicate that the DC-RSs may be communicated via a subset of REs of a shared data channel, and that the DC-RSs may be configured to encode data allocated to the shared channel (e.g., data allocated to the PUSCH or PDSCH). The configuration may specify a modulation coding scheme (MCS) to use in communicating the DC-RS, a quantity of layers, a subset of ports, a pattern of REs, among other parameters. In response to receiving the configuration, the UE may communicate data with the network entity via the indicated REs according to a covariance matrix based on the configuration. The receiver device (e.g., the UE or the network entity) may utilize the DC-RS to estimate the channel and decode corresponding communications.

Aspects of the disclosure are initially described in the context of wireless communications systems. Aspects of the disclosure are further illustrated by and described with reference to DC-RS patterns and process flows. Aspects of the disclosure are further illustrated by and described with reference to apparatus diagrams, system diagrams, and flowcharts that relate to configurations for data-carrying reference signals.

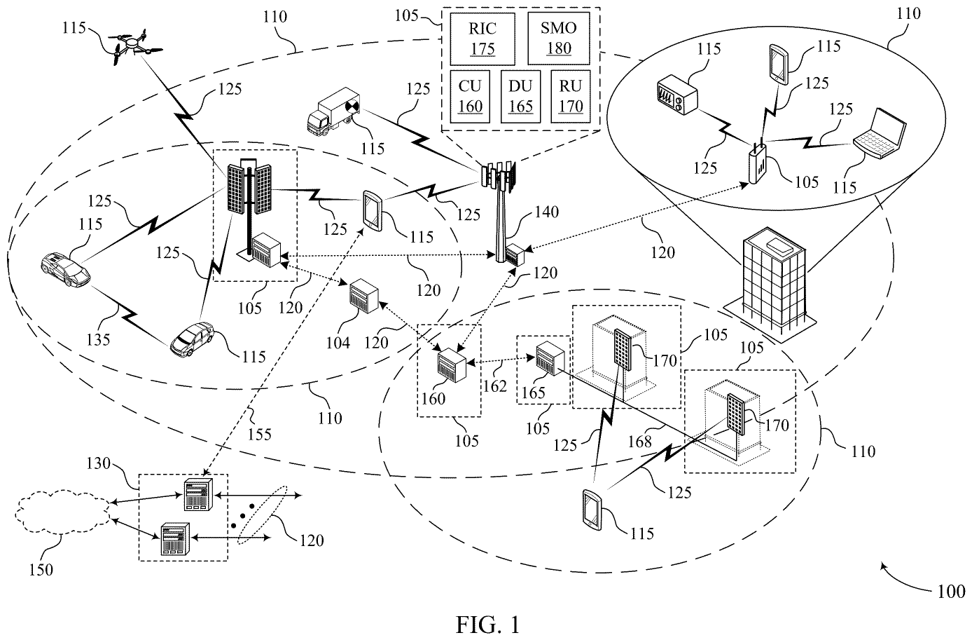

FIG. 1 shows an example of a wireless communications system 100 that supports configurations for DC-RSs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. Components within the wireless communication system 100 may be coupled (for example, operatively, communicatively, functionally, electronically, and/or electrically) to each other

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support configurations for data-carrying reference signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some wireless communication devices (e.g., the UE 115, the network entity 105) may be configured with time-domain resource allocations for various transmissions (e.g., PUSCH transmissions or physical downlink shared channel transmissions) that cross slot boundaries. These configurations may be referred to as fluid SLIV designs. As a result of these configurations, and in order to reduce the DMRS overhead, the DMRS may be transmitted uniformly across the allocation, which may result in reduced DMRS transmissions relative to typical allocations. The reduction in DMRS transmissions may result in receiver devices (e.g., the UE 115, the network entity 105) being unable to perform efficient and accurate channel estimation operations to estimate channel interference. Additional periodic reference signals may be introduced in resource elements (REs) for channel estimation, or null REs may be introduced to avoid collisions between different cells. However, such techniques may impact data throughput, as reference signals or null REs may utilize resources (e.g., REs) typically used for data transmissions.

To increase effectiveness of channel estimation techniques used in determining channel interference, a wireless communications device (e.g., the UE 115, the network entity 105) may communicate DC-RS according to a configuration, and the DC-RS may be used for covariance matrix estimation. For example, the UE 115 may receive (e.g., from the network entity 105) a configuration message configuring the DC-RS that may be included in a PUSCH or PDSCH transmission. The configuration message may indicate that the DC-RSs may be communicated via a subset of REs of a shared data channel, and that the DC-RSs may be configured to encode data allocated to the shared channel (e.g., the PUSCH or PDSCH). The configuration may specify an MCS to use in communicating the DC-RS, a quantity of layers, a subset of ports, a pattern of REs, among other parameters. In response to receiving the configuration, the UE 115 may communicate data with the network entity 105 via the indicated REs according to a covariance matrix based on the configuration.

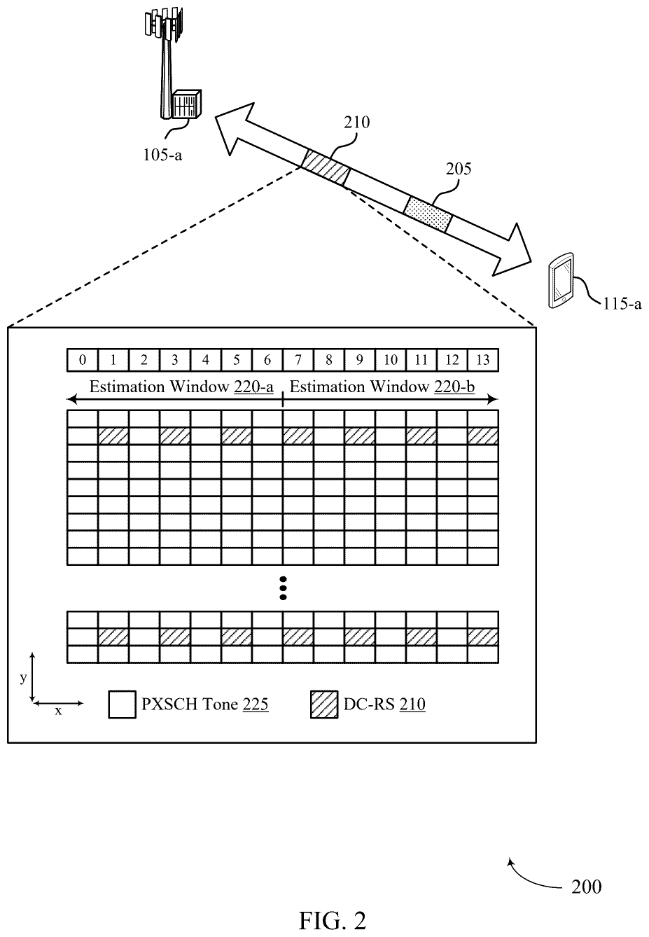

FIG. 2 shows an example of a wireless communications system 200 that supports configurations for DC-RSs in accordance with one or more aspects of the present disclosure. The wireless communications system 200 may include some aspects of a wireless communications system 100. For example, the wireless communications system 200 may include a UE 115-a and a network entity 105-a, which may be respective examples of a UE 115 and a network entity 105 as described with reference to FIG. 1.

The network entity 105-a communicate an indication of a SLIV that may indicate resource allocations that spans across one or more slot boundaries. In some examples, a SLIV which supports indication of a resource allocation spanning one or more slot boundaries may be referred to as a long SLIV or fluid SLIV. In some examples, a long SLIV may include or indicate a length of a resource allocation which is greater than one slot. The long SLIV design may allow the PDSCH or PUSCH support extension of coverage. To reduce DMRS overhead in the wireless communications system 200, a transmitting device (e.g., the network entity 105-a, the UE 115-a) may transmit the DMRS may uniformly across the allocation across multiple slots, which may result in reduced DMRS transmissions relative to non-long SLIV allocations. A time span that includes a group of DMRS symbols may be referred to a channel estimation window. The size of the channel estimation window to allow for DMRS bundling may be dependent on a UE buffer constraint. For example, for downlink, the combinable DMRS resource in adjacent transmission time intervals or slots may be indicated to the receiver UE, and the UE may perform cross SLIV combining. In some low doppler scenarios, when cross-slot DMRS pattern is exploited, a slot may not include a DMRS. In such low doppler cases with sparser DMRS symbols, chances of interference on non-DMRS symbols may be increased, and this interference may not be captured in covariance matrix estimation.

The reduction in DMRS transmissions may result in receiver devices (e.g., the UE 115-a, the network entity 105-a) being unable to perform efficient and accurate channel estimation operations to estimate channel interference. Null REs may be introduced into estimation windows 220 of the shared data channel (e.g., a PUSCH, a PDSCH) transmissions to avoid or limit channel collisions. In some cases, some REs may be used for transmission of channel estimation reference signals. However, the introduction of the null REs or channel estimation reference signals may impact data throughput, as these REs may utilize resources (e.g., REs) used for data transmissions.

To increase effectiveness of channel estimation techniques used in determining channel interference within the wireless communications system 200 and to reduce throughput impact, a wireless communications device (e.g., the UE 115-a, the network entity 105-a) may communicate DC-RS 210 according to a configuration, and the DC-RS 210 may be used for covariance matrix estimation operations and may carry shared channel data. For example, the UE 115-a may receive (e.g., from the network entity 105-a) control signaling 205 including a configuration message that may configure the DC-RS 210 included in a PUSCH or PDSCH transmission. The control signaling 205 (e.g., the configuration message thereof) may indicate that the DC-RSs 210 may be communicated via a subset of REs of a shared data channel, and that the DC-RSs 210 may be configured to encode data allocated to the shared channel. The control signaling 205 may specify an MCS, a quantity of layers, a subset of ports, a pattern of REs, among other parameters, to use in communicating the DC-RSs 210. In response to receiving the control signaling 205, in an uplink scenario, the UE 115-a may encode the PUSCH (e.g., the DC-RS 210 and the PUSCH data) in accordance with the various parameters, and the network entity 105-a may decode the PUSCH based on the various parameters and determine the covariance matrix. In a downlink scenario, the network entity 105-a may encode the PDSCH (e.g., the DC-RS 210 and the PDSCH data) in accordance with the various parameters, and the UE 115-a may decode the PDSCH in accordance with the various parameters and determine the covariance matrix. For example, the UE 115-b may receive the control signaling and may determine a covariance matrix \hat{R}_{NN}.

In one example, the UE 115-a and the network entity 105-a may configure the DC-RSs 210 for each frequency division (FD) window and based on a time division (TD) averaging start and end boundaries. For example, the UE 115-a may configure the DC-RSs 210 for each TD (e.g., time segment) and for each FD window, which may allow the UE 115-a to measure a bursty interference (BI) from neighboring cells. In some examples, phase tracking reference signals (PTRS) may be configured according to each SLIV and according to each FDRA, thus the UE 115-a may not be able to determine the BI based on the PTRS. While use of PTRSs may be ineffective in determining BI, use of the low-density DC-RSs 210 may enable the UE 115-a to successfully determine the BI associated with the shared data channel. In such an example, the UE 115-a may use information bits from the shared data channel (e.g., PUSCH or PDSCH) to construct the DC-RSs 210.

The UE 115-a and the network entity 105-a may also configure modulation and layer details associated with the DC-RSs 210. For example, the UE 115-a or the network entity 105-a may use coded bits of the shared data channel to form Quadrature Phase Shift Keying (QPSK) modulation symbols, quadrature amplitude modulation (QAM) modulation symbols, or both, associated with the DC-RSs 210. By rate matching the shared data channel bits into the modulation symbols associated with the DC-RSs 210, the UE 115-a may avoid introduction of additional code blocks and thus additional encoding operations for the DC-RSs 210. In another example, the UE 115-a or the network entity 105-a may perform modulation operations on the DC-RSs 210 according to a modulation order that may be smaller than or equal to a modulation order of the shared channel REs (e.g., the PXSCH tones 225, wherein “PXSCH” means PUSCH or PDSCH). The modulation order may be configured by the MCS indicated in the control signaling 205. In some examples, the control signaling 205 may also include a modulation order backoff the UE 115-a may use in decreasing a level of the modulation order used on the DC-RSs 210 (e.g., relative to the modulation order of the PXSCH), which may increase effectiveness in DC-RS 210 reconstruction operations. In another example, the network entity 105-a may configure a quantity of layers used in communication of the DC-RSs 210. For example, to increase effectiveness of the DC-RSs 210, the UE 115-a may decrease the quantity of layers (e.g., based on the configuration) used in communication of the DC-RSs 210 such that a quantity of layers associated with the DC-RSs 210 may be less than or equal to a quantity of layers scheduled for the shared data channel.

The receiver device (e.g., the network entity 105-a or the UE 115-a) may use the various parameters indicated in the control signaling 205 to determine a covariance matrix from the shared channel. For example, receiver device may determine a covariance matrix \hat{R}_{NN} according to the following equation:

$${\hat{R}}_{NN} = \frac{1}{N} \sum ( {Y}_{i} - {\hat{H}}_{i} \hat{{x}_{i}} ) {( {Y}_{i} - {\hat{H}}_{i} \hat{{x}_{i}} )}^{′}$$

Where Ĥᵢ represents the channel matrix (e.g., vector) for the i^{th} received DC-RS 210, xi represents the DC-RSs 210, and the receiver vector Yᵢ may be given by:

$${Y}_{i} = {H}_{i} {x}_{i} + {G}_{{i}^{W} i} + {n}_{i} .$$

Where wᵢ represents a precoding matrix and Gᵢ represents a channel variable. After estimating the channel Hi and determining the DC-RSs 210 \hat{x}ᵢ, the receiver device may subtract the signal components associated with the DC-RSs 210 from the received signal to determine the covariance matrix \hat{R}_{NN}.

In some examples, to decrease interference and increase accuracy of the reconstructed DC-RSs 210, the receiver device may iteratively reconstruct the DC-RSs 210 and the covariance matrix \hat{R}_{NN} based on the configuration of the control signaling 205. For example, the receiver device may obtain the initial covariance matrix \hat{R}_{NN} for the 0^{th} iteration, which may be based on associated DMRS or another covariance matrix \hat{R}_{yy} associated with the shared data channel. For example, the covariance matrix \hat{R}_{NN} for the 0^{th} iteration may be as follows:

$${R}_{nn , 0} = \frac{1}{N} {\sum }_{i} {y}_{i} {y}_{i}^{H} - \hat{H} {\hat{H}}^{H}$$

The receiver device may continue performing reconstruction of the DC-RSs 210 and the covariance matrix \hat{R}_{NN} estimation. For example, for the l^{th} iteration, the receiver device may whiten based on R_{nn,l-1} and may perform demapping operations to reconstruct the l^{th} DC-RSs 210 (e.g., \hat{x}ᵢ). In a case that the receiver device may use maximum-ratio combining (MRC) techniques, the precoding matrix may be represented by

$${w}_{l} = {R}_{nn , l - 1}^{- 1} \hat{H}$$

and the reconstructed DC-RS 210 may be reconstructed by performing a “hard slice” operation at a demapper of the receiver device, which may result in the DC-RS 210 represented as:

$$= hard slice ( {w}_{l}^{H} \cdot {y}_{i} )$$

The receiver device may subtract Hx from y, which may result in an l^{th} covariance matrix as follows:

$${R}_{nn , l} = \frac{1}{N} {\sum }_{i} ( {y}_{i} - {H}_{i} ) \times {( {y}_{i} - {H}_{i} )}^{H}$$

The transmitting device (e.g., the network entity 105-a, for example) may indicate a modulation order backoff in the control signaling 205. In some examples, burst interference may decrease the ability of the receiving device (e.g., the UE 115-a, for example) to accurately reconstruct the DC-RSs 210. In the case that the UE 115-a may be unable to reconstruct the DC-RSs 210, the UE 115-a may also be unable to accurately estimate the covariance matrix. To increase gain associated with reconstruction of the DC-RSs 210 and the estimation of the covariance matrix, the control signaling 205 may configure a modulation order backoff for the DC-RSs 210 such that the modulation order associated with the DC-RSs 210 may be different from a modulation associated with a scheduled MCS of the shared data channel.

In some cases, RRC signaling (e.g., the control signaling 205) may include a backoff order that may decrease the DC-RSs 210 modulation order for different MCS values. For example, the network entity 105-a may determine interference at a cell edge associated with a UE 115-a, and may indicate (e.g., via the control signaling 205) a backoff order that may decrease the modulation order of the DC-RS 210 for each MCS value. After the UE 115-a applies the backoff order configuration, the modulation order of the DC-RSs 210 may be equivalent to the modulation order of the scheduled shared data channel without (e.g., removing, minus) the backoff value corresponding to the scheduled MCS. Thus, the modulation order of the DC-RSs 210 may be less than or equal to the modulation order of the scheduled MCS for the PDSCH or PUSCH transmission.

In another example, DCI signaling (e.g., the control signaling 205) may include a backoff order that may decrease the DC-RSs 210 modulation order. For example, the DCI associated with (e.g., indicating) the SLIV of the shared channel may indicate a modulation order offset for the DC-RSs 210. The UE 115-a may apply the modulation order offset to each of the estimation windows 220. In a case that the estimation windows 220 may each be associated with a different interference level, the network entity 105-a may indicate different modulation order offsets via the DCI for each of the estimation windows 220 (e.g., the estimation window 220-a, the estimation window 220-b, the estimation windows in the SLIV). In some examples, to decrease use of DCI fields, the network entity 105-a may configure a limited set of backoff orders for each MCS value (e.g., of the scheduled MCS) and indicate the set via RRC signaling. In such cases, the network entity 105-a may indicate a modulation order backoff of the limited set of backoff orders via the DCI.

The UE 115-a and the network entity 105-a may determine transport block (TB) size of the PDSCH or PUSCH that includes the DC-RS 210. In some techniques, a quantity of unquantized information bits may be represented by the following equation:

$${N}_{info} = {N}_{RE} {RQ}_{m} v$$

where R represents an indicated code rate, Qₘ represents a modulation order, and v represents a quantity of layers. For some techniques associated with use of PTRSs for covariance matrix estimation and signal reconstruction, devices in some wireless communications systems may account for PTRS resource overhead during determination of TB size. In some examples, the UE 115-a may include the REs associated with the DC-RSs 210 in the quantity of REs used to determine the transport block size, and may use a same modulation order and quantity of layers for the REs associated with the DC-RSs 210 as is associated with data REs for TB size determination. Additionally, or alternatively, the UE 115-a may estimate a quantity of information bits that may be carried in the DC-RSs 210 using the modulation order and the quantity of layers associated with the DC-RSs 210 for TB size termination. In some other examples, the UE 115-a may compute the unquantized quantity of information associated with the REs of the DC-RSs 210 based on the modulation order and rank of the DC-RSs 210 according to one or more of the following equations:

$${N}_{info} = {N}_{info , dataREs} + {N}_{info , DCRS}$$

$${N}_{info , DCRS} = {N}_{RE , DCRS} {RQ}_{m , DCRS} {v}_{DCRS}$$

where R represents an indicated code rate, Qₘ represents the modulation order, and v represents a quantity of layers.

In some examples, the UE 115-a and the network entity 105-a may configure a rank of the DC-RSs 210. A high rank of the DC-RSs 210 may decrease overhead in the case that the shared data channel may be scheduled with multiple layers, thus it may be beneficial to configure the rank of the DC-RSs 210 to be the same rank as the rank of the shared data channel. However, while a high rank may decrease overhead associated with the shared data channel, a low rank of the DC-RSs 210 may enable a demapper to avoid cross layer interference. Additionally, or alternatively, the DC-RSs 210 being associated with a same rank (e.g., a rank greater than 1) and precoder as the shared data channel may also help devices in the wireless communications system 200 to account for interference in the case that a DC-RS 210 in a neighboring cell may collide with a DC-RS 210 of a target cell. To decrease collisions, various techniques such as pattern randomization by a transmitting device and configuration of the DC-RSs 210 according to a same spatial signature as the shared data channel may be implemented.

To decrease overhead associated with transmission of the DC-RSs 210, the UE 115-a and the network entity 105-a may configure ports associated with the DC-RSs 210. For example, the control signaling 205 may include a configuration for one or more ports of the DC-RSs 210 such that one or more of the ports may be quasi co-located with ports associated with the DMRS associated with the shared data channel. By configuring the ports of the DC-RSs 210 as such, one or more ports of the DC-RS 210 may use a same precoder as the ports of the DMRSs. In the case that the ports of the DC-RS 210 are configured to use a same precoder as the DMRS ports, the receiver device may perform a per-port channel estimation operation to determine the DC-RSs 210 from the multiple received signals and to estimate an associated covariance matrix.

In some examples, a quantity of layers associated with the DC-RSs 210 that the UE 115-a (e.g., or another receiving device) may reliably reconstruct (e.g., using hard-slicing) may be based on a quantity of receiver antennas and a rank of interference at the UE 115-a. For example, a high rank of interference and a large quantity of layers associated with the DC-RSs 210 may prevent the receiver device from effectively disregarding interference during reconstruction of the DC-RSs 210. However, a large quantity of receiver antennas may increase the ability of the receiver device to reconstruct the DC-RSs 210.

To increase ability of the receiver device to effectively reconstruct the DC-RSs 210, RRC signaling associated with the control signaling 205 may include a configuration associated with a backoff order for a quantity of layers associated with the DC-RSs 210 and a backoff order for a modulation order associated with the DC-RSs 210. For example, while using a same quantity of layers for the DC-RSs 210 as for the data REs may decrease overhead associated with use of the shared data channel, decreasing the modulation order from the scheduled modulation order may increase accuracy of the DC-RSs 210 reconstruction operations in the case of high levels of interference. Additionally, or alternatively, the configuration may include a backoff order for both a rank and a modulation order associated with the DC-RSs 210, which may increase accuracy of the DC-RSs 210 reconstruction operations at the receiver device in a case that the cross layer interference may not be easily nulled.

In some examples, DCI associated with the shared data channel may indicate a rank or a modulation order of the DC-RSs 210 dynamically. For example, the network entity 105-a may determine whether the receiver may be able to reconstruct the DC-RSs 210 based on a state of the interference of the shared channel or other conditions, and may dynamically adapt the rank, modulation order, or both, of the DC-RSs 210 based on a rank backoff indicated via the DCI. The rank backoff indicated by the DCI may be a backoff order with respect to a rank associated with the data REs. By enabling the network entity 105-a to dynamically adjust the rank of the DC-RSs 210 using DCI, the network entity 105-a may be able to increase the rank in the case of poor channel conditions and decrease the modulation order (e.g., based on a carrier to interference plus noise ratio (CINR)) in the case of good channel conditions, which may increase the effectiveness of DC-RS 210 reconstruction operations at the receiver.

DCI may also indicate one or more ports associated with the DC-RSs 210 for use in transmission of the DC-RSs 210. In the case that a quantity of layers of the DC-RSs 210 may be less than a quantity of layers of the shared data channel, the network entity 105-a may use DCI to indicate which of the ports may be associated with strongest layers of the quantity of layers. For example, the DCI may indicate a bitmap to the UE 115-a, where each bit of the bitmap may be associated with a port of the schedules DMRS ports. The network entity 105-a may indicate one or more ports to use in transmissions by a set bit indicated by the DCI for each port to be used. In some examples, the network entity 105-a may use a joint encoding technique on ports of the DMRS and ports of the DC-RSs 210. For example, the UE 115-a and the network entity 105-a may use a table of DMRS ports, the DC-RS ports, a quantity of DMRS CDM groups that may not include data, or a combination thereof (e.g., a quantity of the DC-RS ports may also be DMRS ports). To indicate which ports to use, the network entity 105-a may indicate an entry index of the table to the UE 115-a via the DCI.

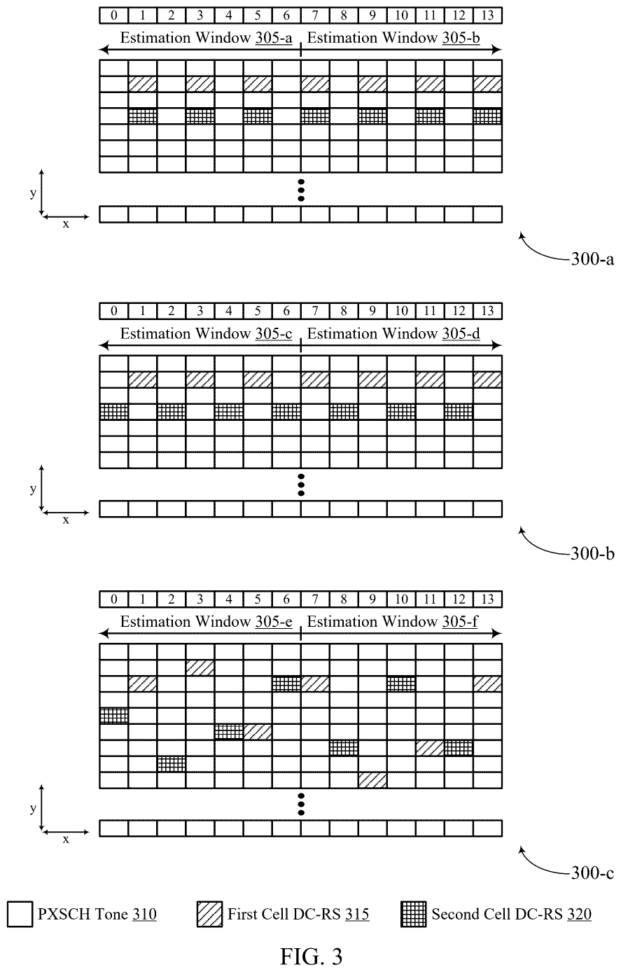

In cases when a quantity of layers of the DC-RSs 210 is less than a number of layers used for transmissions in an inferencing cell and the DC-RSs 210 of both cells collide, the spatial signatures of the interfering cell's DC-RS 210 may be different. Different spatial signatures may impact channel estimation techniques. Accordingly, to decrease collisions between DC-RSs 210 of different cells, communications in the different cells may be configured with separate TD and FD frequency patterns for the DC-RSs 210. For example, the network entity 105-a a may configure each of the respective DC-RSs 210 associated with two cells according to a cell-dependent tone offset configuration. In another example, the network entity 105-a may configure each of the respective DC-RSs 210 associated with two cells with a cell-dependent symbol offset such that each DC-RS 210 (e.g., associated with a respective cell) may occupy different symbols. In one case, the network entity 105-a configure each of the respective DC-RSs 210 according to a dependent random tone offset at different RS symbols. DC-RS 210 pattern configuration techniques are further illustrated and described with respect to FIG. 3.

Thus, using the techniques described herein, the UE 115-a and the network entity 105-a may communicate data via the DC-RSs 210. For example, in response to receiving the control signaling 205 and configuring the DC-RSs 210, the UE 115-a may transmit data to the network entity 105-a via REs of the shared data channel, and the UE 115-a may communicate one or more portions of the data in one or more of the DC-RSs 210 via the REs of the shared data channel. Communicating data via the DC-RSs 210 configured according to a covariance matrix may increase effectiveness of channel estimation techniques used by receiving devices (e.g., the UE 115-a, the network entity 105-a) in determining channel interference and may limit data throughput impacts associated with other techniques

FIG. 3 shows an example of DC-RS patterns 300 that support configurations for DC-RSs in accordance with one or more aspects of the present disclosure. The DC-RS patterns 300 may include or may be implemented by some aspects of a wireless communications system 100 and a wireless communications system 200. For example, the DC-RS patterns 300 (e.g., a DC-RS pattern 300-a, a DC-RS pattern 300-b, a DC-RS pattern 300-c) may include one or more estimation windows 305, which may be examples of estimation windows 220 over which a UE 115, a network entity 105, or both, may perform estimation operations on a shared data channel (e.g., a PUSCH, a PDSCH) as described herein with reference to FIGS. 1 and 2. The DC-RS patterns 300 may also include examples of DC-RSs for different cells (e.g., first cell DC-RSs 315, second cell DC-RSs 320) used for transmission of a shared data channel. Techniques described with reference to the DC-RS patterns 300 may be performed by a UE 115, a network entity 105, or a combination thereof, as further described herein.

Each of the DC-RS patterns 300 may include multiple of each of the first cell DC-RSs 315, the second cell DC-RSs 320, and the PXSCH tones 310. Each of the various first cell DC-RSs 315, the second cell DC-RSs 320, and the PXSCH tones 310 may be associated with an estimation window 305, and may be located in (e.g., encoded into) a DMRS symbol of the shared channel, which may be represented by a single unit in an x-direction and a y-direction of an estimation window 305.

To decrease collisions of DC-RSs communications between a UE and a network entity in one cell with communications in another cell, various patterns of DC-RSs may be configured. For example, one or more network entities may configure the first cell DC-RSs 315 and the second cell DC-RSs 320 according to a cell-dependent tone offset configuration. The pattern used for a cell may be dependent on an identifier of the cell used for communications. Thus, for each of the DC-RS patterns 300, the positions of the first cell DC-RSs 315 may be dependent on the cell identifier of the first cell, and the positions of the second cell DC-RSs may be dependent on the cell identifier of the second cell. Thus, the cell identifiers may be implicitly indicative of the patterns of respective DC-RSs used for communications in the respective cells.

As illustrated by the DC-RS pattern 300-a, a first cell may include multiple first cell DC-RSs 315, and a second cell may include multiple second cell DC-RSs 320 evenly dispersed within an estimation window 305-a and an estimation window 305-b. The second cell DC-RS 320 may be offset (e.g., in a y-direction) from the first cell DC-RS 315 to avoid collisions. PXSCH tones 310 may be interspersed in between each of the first cell DC-RSs 315 and the second cell DC-RSs 320 in both the y-direction and the x-direction, such that each of the first cell DC-RSs 315 and the second cell DC-RSs 320 may be separated by a single PXSCH tone 310 in the y-direction while occupying the same symbols within the estimation window 305-a and an estimation window 305-b (e.g., symbol 1, symbol 3, symbol 5, and so on).

Additionally, or alternatively, one or more network entities may configure the first cell DC-RSs 315 and the second cell DC-RSs 320 according to a cell-dependent symbol offset such that each DC-RS (e.g., associated with a respective cell) may occupy different symbols within estimation windows. As illustrated by the DC-RS pattern 300-b, the cell-dependent DC-RS configuration including symbols offsets may include multiple first cell DC-RSs 315 and multiple second cell DC-RSs 320 evenly dispersed within an estimation window 305-c and an estimation window 305-d. PXSCH tones 310 may be interspersed in between each of the first cell DC-RSs 315 and the second cell DC-RSs 320 in both the y-direction and the x-direction, such that each of the first cell DC-RSs 315 and the second cell DC-RSs 320 may be separated by a single PXSCH tone 310 in both the y-direction and the x-direction. The DC-RS pattern 300-b may also include a symbol offset in the x-direction such that the first cell DC-RSs 315 and the second cell DC-RSs 320 may occupy different symbols within the estimation window 305-c and the estimation window 305-d. For example, as a result of the symbol offset, the first cell DC-RSs 315 may be located in symbols 1, 3, 5, and others, while the second cell DC-RSs 320 may be located in symbols 0, 2, 4, and so on.

Additionally, or alternatively, the network entity may configure the first cell DC-RSs 315 and the second cell DC-RSs 320 according to a dependent random tone offset at different RS symbols. As illustrated by the DC-RS pattern 300-c, the dependent random tone offset configuration may include multiple first cell DC-RSs 315 and multiple second cell DC-RSs 320 randomly dispersed within an estimation window 305-e and an estimation window 305-f. PXSCH tones 310 may be interspersed in between each of the first cell DC-RSs 315 and the second cell DC-RSs 320 in both the y-direction and the x-direction, such that each of the first cell DC-RSs 315 and the second cell DC-RSs 320 may be separated by varying quantities of the PXSCH tones 310 in both the y-direction and the x-direction. The DC-RS pattern 300-c may also include varying symbol offsets in both the y-direction and the x-direction such that the first cell DC-RSs 315 and the second cell DC-RSs 320 may occupy random, separate RS symbols within the estimation window 305-e and the estimation window 305-f. For example, as a result of the random symbol offset, the first cell DC-RSs 315 may be located in symbols 1, 3, 5, and others, while the second cell DC-RSs 320 may be located in symbols 0, 2, 4, and so on, such that the symbols may be randomly dispersed in the y-direction.

While the DC-RS pattern 300-a, the DC-RS pattern 300-b, and the DC-RS pattern 300-c illustrate three separate configurations of DC-RSs for a UE and a network entity to use in communicating data, the UE and the network entity may use a combination of one or more of the DC-RS patterns 300.

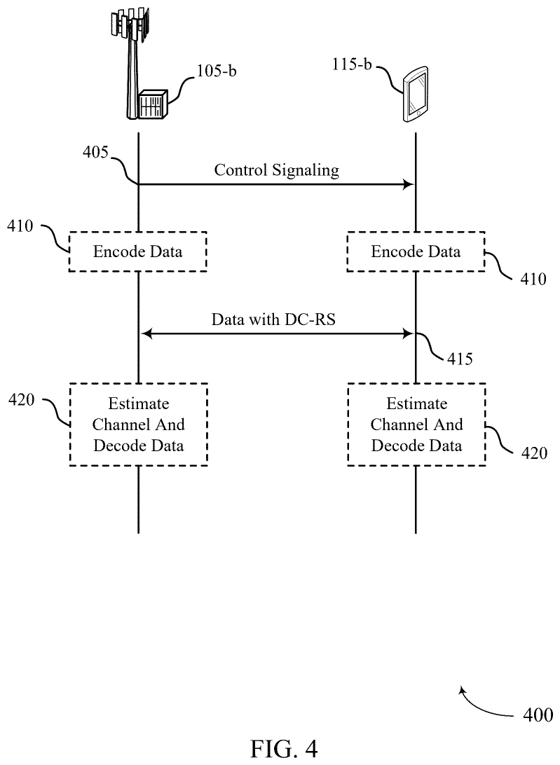

FIG. 4 shows an example of a process flow 400 that supports configurations for data-carrying reference signals in accordance with one or more aspects of the present disclosure. Aspects of the process flow 400 may implement, or be implemented by, aspects of the wireless communications system 100. For example, the process flow 400 illustrates various signals and operations that enable communication of DC-RS according to a configuration, covariance matrix estimation operations, and the communication of data via the DC-RS according to the estimated covariance matrix. The process flow 400 includes a UE 115-b and a network entity 105-b, which may be examples of UEs 115, network entities 105, and other wireless devices as described with reference to FIGS. 1 and 2.

In some examples, the operations illustrated in process flow 400 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the network entity 105-b may transmit, and the UE 115-b may receive, control signaling. The control signaling may be indicative of a configuration for multiple DC-RSs associated with estimation of a covariance matrix. In some examples, the control signaling may indicate a respective configuration for each covariance matrix estimation window of two or more windows. The configuration may indicate that the UE 115-b and the network entity 105-b may communicate the DC-RSs via a subset of REs of one or more REs of a shared data channel (e.g., a PDSCH, a PUSCH). The configuration may also indicate that the DC-RSs may be configured to encode a portion of data allocated to the shared data channel. In some examples, the configuration may also indicate a modulation order for encoding the DC-RSs. The modulation order may be the same as or smaller than (e.g., or both) a modulation order used for encoding data of the shared data channel separate from the DMRSs. The configuration may also indicate a first quantity of layers to be used for communication of the DC-RSs. In some examples, the first quantity of layers may be equal to or less than a second quantity of layers used in communication of the shared data channel (e.g., separate from the DMRSs). In some cases, the configuration may indicate one or more ports associated with the DC-RSs. The one or more ports may be at least partially located at a location of ports associated with DMRSs of the shared data channel.

In some examples, the control signaling may also be indicative of a pattern of the subset of REs within the one or more of REs allocated for communication via the shared data channel. The network entity 105-b may indicate the pattern (e.g., to the UE 115-b) via a cell identifier associated with a tone offset, a symbol offset, a random tone offset at different symbols, or a combination thereof. In some examples, the control signaling may also indicate a layer quantity backoff value for communication of the DC-RSs, a modulation order backoff value for communication of the DC-RSs, or a combination thereof (e.g., as further described herein).

The control signaling may also indicate a subset of ports (e.g., of multiple ports) to use for transmission of the DC-RSs. In some examples, the network entity 105-b may transmit, and the UE 115-b may receive, a bitmap as part of the control signaling. The bitmap may indicate the subset of ports for use in transmitting the DC-RSs. Each value of the bitmap may be associated with a respective DC-RS port configured for communication via the shard data channel. In some examples, the network entity 105-b may transmit, and the UE 115-b may receive, an indication of a subset of DMRS ports to use for communication of the shared data channel. The subset of ports for use in transmitting the DC-RSs may be associated with the subset of DMRS ports. The network entity 105-b may transmit, and the UE 115-b may receive, an indication of an index that may be mapped to the subset of ports (e.g., the subset of ports for use in transmitting the DC-RSs) via a table. The table may map one or more indexes to respective subsets of ports associated with transmission of the DC-RSs.

In some examples, the control signaling may be an example of or be included in RRC signaling. The network entity 105-b may communicate, and the UE 115-b may receive, RRC signaling that may indicate the layer quantity backoff value for communication of the DC-RSs. The RRC signaling may also indicate a modulation order backoff value for communication of the DC-RSs, a set of modulation order backoff values for communication of the DC-RSs, a subset of ports to use for transmission of the DC-RSs, or a combination thereof.

Additionally, or alternatively, the control signaling may be an example of or be included in DCI signaling. The network entity 105-b may communicate, and the UE 115-b may receive, DCI signaling that may indicate the layer quantity backoff value for communication of the DC-RSs. The DCI signaling may also indicate a modulation order backoff value for communication of the DC-RSs that may schedule communication of the shared data channel. The UE 115-b may apply the modulation order backoff value to each of a first covariance matrix estimation window and a second covariance matrix estimation window of the windows indicated by the control signaling. In other examples, the DCI signaling may indicate two modulation order backoff values, and the UE 115-b may apply a first of the modulation order backoff values to a first covariance matrix estimation window and a second of the modulation order backoff values to a second covariance matrix estimation window. In some examples, the DCI signaling may indicate a modulation order backoff value from a set of modulation order backoff values indicated by the RRC signaling.

At 410, in a downlink scenario, the network entity 105-b may encode the data of the PDSCH into the resource elements of the PDSCH and at least a portion of the data into the DC-RSs in accordance with the control signaling. At 410, in an uplink scenario, the UE 115-b may encode the data of the PUSCH into the resource elements of the PUSCH and at least a portion of the data into the DC-RSs in accordance with the control signaling.

At 415, data may be communicated. For example, the network entity 105-b may transmit and the UE 115-b may receive, or the UE 115-b may transmit and the network entity 105-b may receive, data allocated to the shared data channel (e.g., PDSCH or PUSCH) via the REs of the shared channel. The UE 115-b and the network entity 105-b may communicate a first portion of the data encoded in one or more DC-RSs via a first subset of REs of the shared data channel, and may communicate a second portion of the data via a second subset of REs of the shared data channel. In some examples, the UE 115-b and the network entity 105-b may communicate the first portion of the data encoded in the one or more DC-RSs via the first subset of REs using a quantity of layers that may be based on the indicated layer quantity backoff value and another quantity of layers configured for communication of the shared data channel. In the case that the control signaling may indicate a modulation order backoff value, the UE 115-b and the network entity 105-b may encode the DC-RSs using a modulation order that may be based on the modulation order backoff value and using a modulation order configured for communication via the shared data channel, and the UE 115-b and the network entity 105-b may communicate the encoded DC-RSs via the first subset of REs. The UE 115-b and the network entity 105-b may communicate the data based on the ports indicated by the configuration. For example, in the case that the control signaling may indicate a subset of ports to use for transmission of the DC-RSs, the UE 115-b and the network entity 105-b may communicate the DC-RSs via the subset of ports. In some examples, the subset of ports indicated by the control signaling may be different from ports used for communication of the shared data channel.

At 420, in a downlink scenario, the UE 115-b may estimate the channel based on the DC-RSs and decode the data of the shared data channel (e.g., the PDSCH) using information received in the control signaling. At 420, in an uplink scenario, the network entity 105-b may estimate the channel based on the DC-RSs and decode the data of the shared data channel (e.g., the PUSCH) using information transmitted in the control signaling. As part of decoding, the UE 115-a or the network entity 105-a may determine a transport block size for the shared data channel based on a quantity of REs and a modulation order scheduled for communication via the shared channel. In some examples, the quantity of REs and the modulation order may be indicated by the configuration (e.g., indicated by the control signaling received by the UE 115-b at 405). In other examples, the network entity 105-a or the UE 115-b may determine the transport block size for the shared data channel based on a quantity of REs of a second subset of REs of the REs of the shared data channel, a first modulation order for encoding the shared data channel, a quantity of REs of a first subset of REs, and a second modulation order for encoding the DC-RSs.

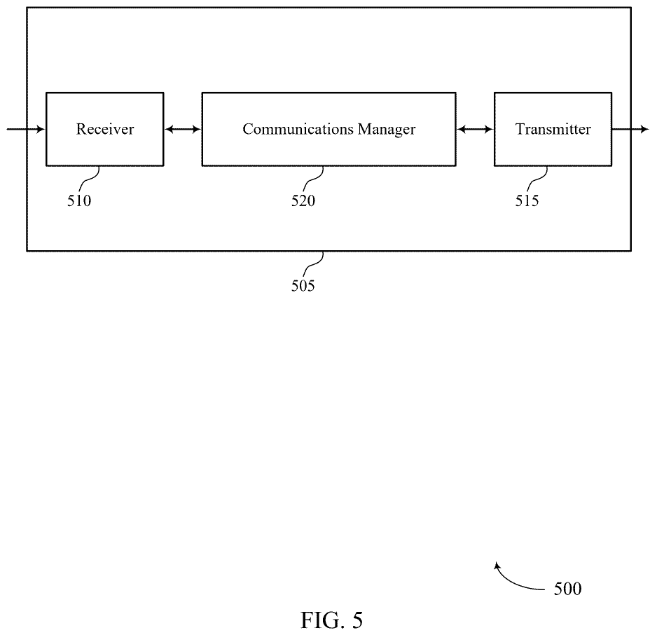

FIG. 5 shows a block diagram 500 of a device 505 that supports configurations for data-carrying reference signals in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to configurations for data-carrying reference signals). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configurations for data-carrying reference signals). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of configurations for data-carrying reference signals as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure). Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The communications manager 520 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

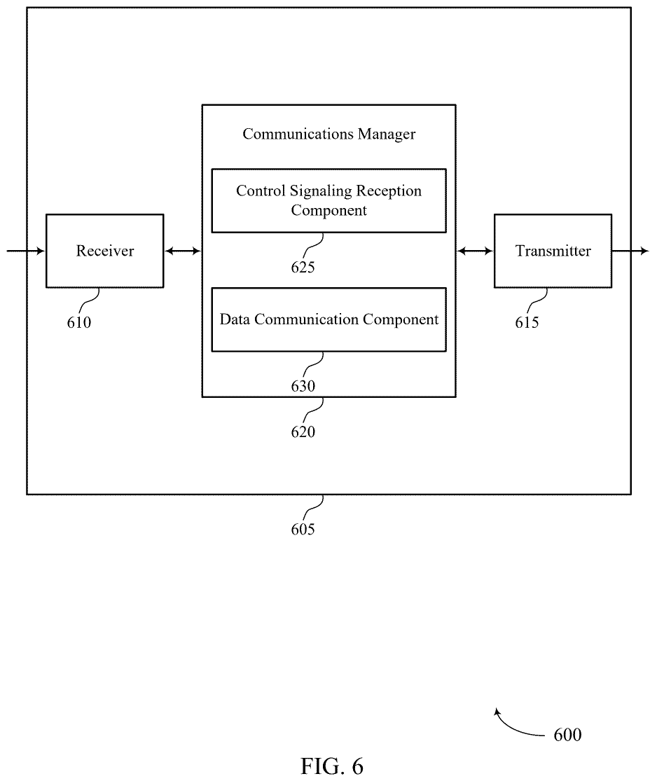

FIG. 6 shows a block diagram 600 of a device 605 that supports configurations for data-carrying reference signals in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configurations for data-carrying reference signals). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configurations for data-carrying reference signals). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of configurations for data-carrying reference signals as described herein. For example, the communications manager 620 may include a control signaling reception component 625 a data communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control signaling reception component 625 is capable of, configured to, or operable to support a means for receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The data communication component 630 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

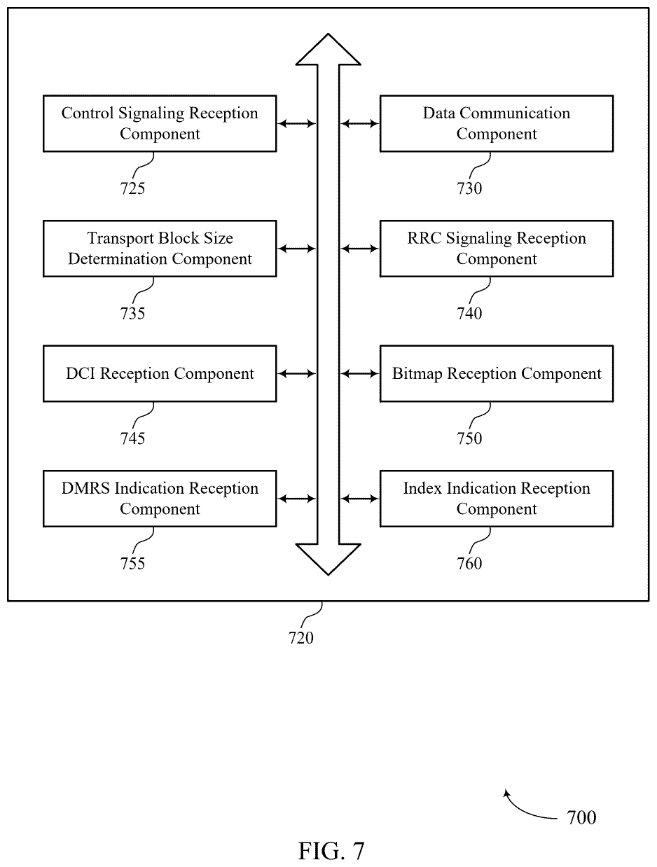

FIG. 7 shows a block diagram 700 of a communications manager 720 that supports configurations for data-carrying reference signals in accordance with one or more aspects of the present disclosure. The communications manager 720 may be an example of aspects of a communications manager 520, a communications manager 620, or both, as described herein. The communications manager 720, or various components thereof, may be an example of means for performing various aspects of configurations for data-carrying reference signals as described herein. For example, the communications manager 720 may include a control signaling reception component 725, a data communication component 730, a transport block size determination component 735, an RRC signaling reception component 740, a DCI reception component 745, a bitmap reception component 750, a DMRS indication reception component 755, an index indication reception component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control signaling reception component 725 is capable of, configured to, or operable to support a means for receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The data communication component 730 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

In some examples, the control signaling is indicative of a layer quantity backoff value for communication of the set of multiple data-carrying reference signals. In some examples, the set of multiple data-carrying reference signals are communicated via the first subset of resource elements using a second quantity of layers that is based on the layer quantity backoff value and a first quantity of layers configured for communication of the shared data channel.

In some examples, to support receiving the control signaling, the RRC signaling reception component 740 is capable of, configured to, or operable to support a means for receiving radio resource control signaling that is indicative of the layer quantity backoff value.

In some examples, to support receiving the control signaling, the DCI reception component 745 is capable of, configured to, or operable to support a means for receiving downlink control information that is indicative of the layer quantity backoff value and that schedules communication of the shared data channel.

In some examples, the control signaling is indicative of a modulation order backoff value for communication of the set of multiple data-carrying reference signals. In some examples, the set of multiple data-carrying reference signals are communicated via the first subset of resource elements and encoded using a second modulator order that is based on the modulation order backoff value and a first modulation order configured for communication of the shared data channel.

In some examples, to support receiving the control signaling, the RRC signaling reception component 740 is capable of, configured to, or operable to support a means for receiving radio resource control signaling that is indicative of the modulation order backoff value.

In some examples, to support receiving the control signaling, the DCI reception component 745 is capable of, configured to, or operable to support a means for receiving downlink control information that is indicative of the modulation order backoff value and that schedules communication of the shared data channel.

In some examples, the modulation order backoff value is to be applied to a first covariance matrix estimation window and a second covariance matrix estimation window.

In some examples, the downlink control information indicates the modulation order backoff value that is a first modulation order backoff value to be applied for a first covariance matrix estimation window and the downlink control information indicates a second modulation order backoff value to be applied for a second covariance matrix estimation window.

In some examples, to support receiving the control signaling, the RRC signaling reception component 740 is capable of, configured to, or operable to support a means for receiving radio resource control signaling including a set of modulation order backoff values. In some examples, to support receiving the control signaling, the DCI reception component 745 is capable of, configured to, or operable to support a means for receiving downlink control information indicative of the modulation order backoff value from the set of modulation order backoff values.

In some examples, the control signaling is indicative of a subset of ports of a set of multiple ports to use for transmission of the set of multiple data-carrying reference signals. In some examples, the set of multiple data-carrying reference signals are communicated via the subset of ports that is different from one or more ports used for communication of the shared data channel.

In some examples, to support receiving the control signaling, the DCI reception component 745 is capable of, configured to, or operable to support a means for receiving downlink control information message that is indicative of the subset of ports.

In some examples, to support receiving the control signaling, the bitmap reception component 750 is capable of, configured to, or operable to support a means for receiving a bitmap indicative of the subset of ports, where each value of the bitmap is associated with a respective DMRS port configured for communication of the shared data channel.

In some examples, to support receiving the control signaling, the DMRS indication reception component 755 is capable of, configured to, or operable to support a means for receiving an indication of a subset of demodulation reference signal ports to use for communication of the shared data channel and where the subset of ports to use for communication of the set of multiple data-carrying reference signals corresponds to the subset of demodulation reference signal ports.

In some examples, to support receiving the control signaling, the index indication reception component 760 is capable of, configured to, or operable to support a means for receiving an indication of an index that is mapped to the subset of ports via a table that maps a set of multiple indexes to respective subsets of ports.

In some examples, the control signaling is indicative of a pattern of the first subset of resource elements within the set of multiple resource elements allocated for communication of the shared data channel.

In some examples, the pattern is indicated via a cell identifier associated with a tone offset, a symbol offset, a random tone offset at different symbols, or a combination thereof.

In some examples, the control signaling is indicative of a respective configuration per covariance matrix estimation window of two or more covariance matrix estimation windows.

In some examples, the configuration further specifies a first modulation order used for encoding the set of multiple data-carrying reference signals, the first modulation order being a same modulation order as a second modulation order used for encoding data of the shared data channel separate from the set of multiple data-carrying reference signals or being a smaller modulation order than the second modulation order.

In some examples, the configuration further specifies a first quantity of layers to be used for communication of the set of multiple data-carrying reference signals, the first quantity of layers being equal to or less than a second quantity of layers used for communication of the shared data channel separate from the set of multiple data-carrying reference signals.

In some examples, the configuration further specifies a set of multiple ports associated with the set of multiple data-carrying reference signals, the set of multiple ports being at least partially located at a location of a set of multiple ports associated with demodulated reference signals of the shared data channel. In some examples, communicating the data is based on the set of multiple ports.

In some examples, the transport block size determination component 735 is capable of, configured to, or operable to support a means for determining a transport block size for the shared data channel based on a quantity of resource elements of the set of multiple resource elements and a modulation order scheduled for communication of the shared data channel.

In some examples, the transport block size determination component 735 is capable of, configured to, or operable to support a means for determining a transport block size for the shared data channel based on a first quantity of resource elements in the second subset and a first modulation order used for encoding the shared data channel and a second quantity of resource elements in the first subset and a second modulation order used for encoding the set of multiple data-carrying reference signals.

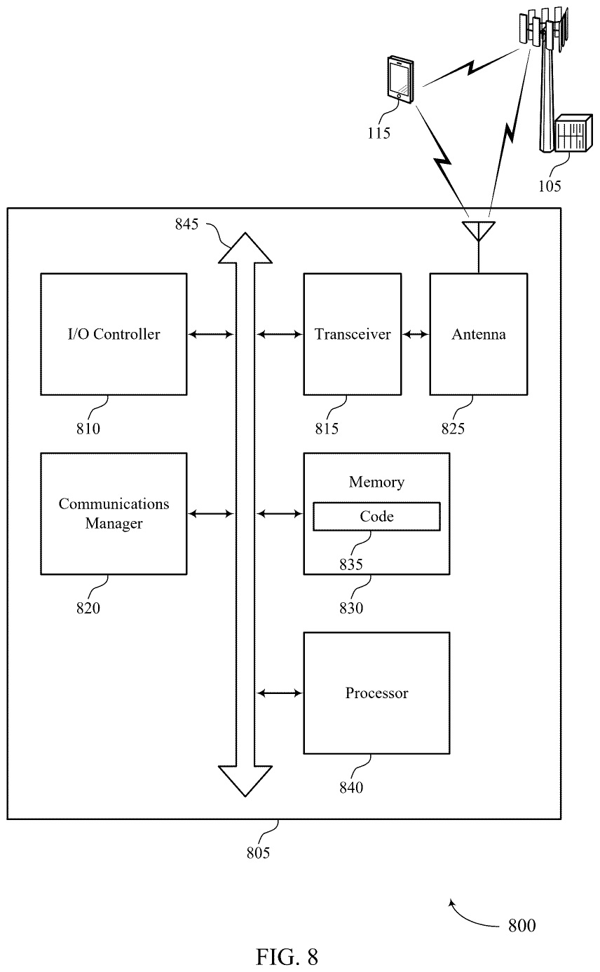

FIG. 8 shows a diagram of a system 800 including a device 805 that supports configurations for data-carrying reference signals in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting configurations for data-carrying reference signals). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The communications manager 820 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of configurations for data-carrying reference signals as described herein, or the at least one processor 840 and the at least one memory 830 may be otherwise configured to, individually or collectively, perform or support such operations.

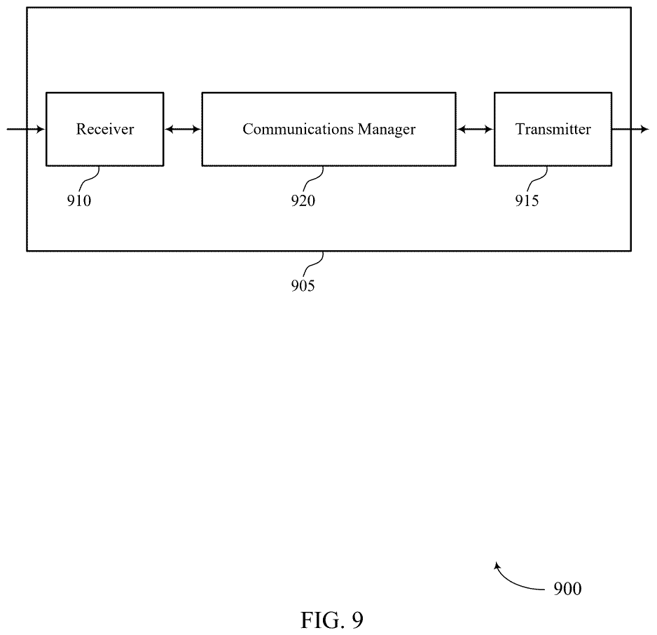

FIG. 9 shows a block diagram 900 of a device 905 that supports configurations for data-carrying reference signals in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of configurations for data-carrying reference signals as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The communications manager 920 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

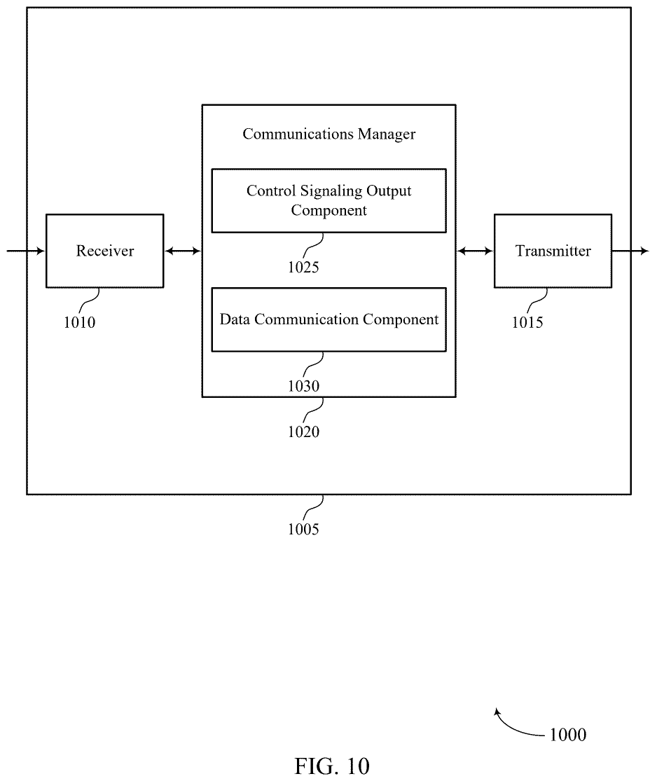

FIG. 10 shows a block diagram 1000 of a device 1005 that supports configurations for data-carrying reference signals in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of configurations for data-carrying reference signals as described herein. For example, the communications manager 1020 may include a control signaling output component 1025 a data communication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling output component 1025 is capable of, configured to, or operable to support a means for outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The data communication component 1030 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

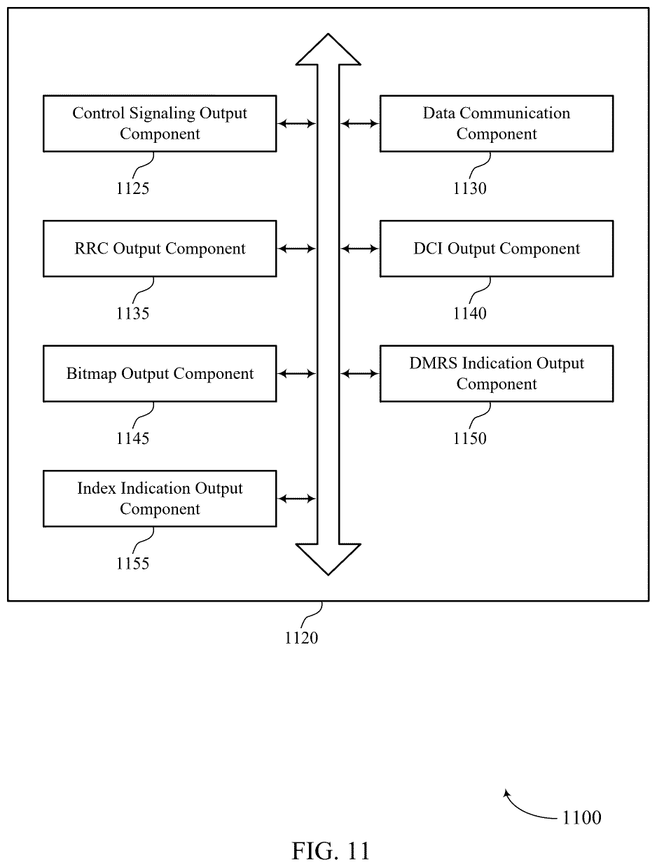

FIG. 11 shows a block diagram 1100 of a communications manager 1120 that supports configurations for data-carrying reference signals in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of configurations for data-carrying reference signals as described herein. For example, the communications manager 1120 may include a control signaling output component 1125, a data communication component 1130, an RRC output component 1135, a DCI output component 1140, a bitmap output component 1145, a DMRS indication output component 1150, an index indication output component 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control signaling output component 1125 is capable of, configured to, or operable to support a means for outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The data communication component 1130 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

In some examples, the control signaling is indicative of a layer quantity backoff value for communication of the set of multiple data-carrying reference signals. In some examples, the set of multiple data-carrying reference signals are communicated via the first subset of resource elements using a second quantity of layers that is based on the layer quantity backoff value and a first quantity of layers configured for communication of the shared data channel.

In some examples, to support outputting the control signaling, the RRC output component 1135 is capable of, configured to, or operable to support a means for outputting radio resource control signaling that is indicative of the layer quantity backoff value.

In some examples, to support outputting the control signaling, the DCI output component 1140 is capable of, configured to, or operable to support a means for outputting downlink control information that is indicative of the layer quantity backoff value and that schedules communication of the shared data channel.

In some examples, the control signaling is indicative of a modulation order backoff value for communication of the set of multiple data-carrying reference signals. In some examples, the set of multiple data-carrying reference signals are communicated via the first subset of resource elements and encoded using a second modulator order that is based on the modulation order backoff value and a first modulation order configured for communication of the shared data channel.

In some examples, to support outputting the control signaling, the RRC output component 1135 is capable of, configured to, or operable to support a means for outputting radio resource control signaling that is indicative of the modulation order backoff value.

In some examples, to support outputting the control signaling, the DCI output component 1140 is capable of, configured to, or operable to support a means for outputting downlink control information that is indicative of the modulation order backoff value and that schedules communication of the shared data channel.

In some examples, the modulation order backoff value is to be applied to a first covariance matrix estimation window and a second covariance matrix estimation window.

In some examples, the downlink control information indicates the modulation order backoff value that is a first modulation order backoff value to be applied for a first covariance matrix estimation window and the downlink control information indicates a second modulation order backoff value to be applied for a second covariance matrix estimation window.

In some examples, to support outputting mitting the control signaling, the RRC output component 1135 is capable of, configured to, or operable to support a means for outputting radio resource control signaling including a set of modulation order backoff values. In some examples, to support outputting mitting the control signaling, the DCI output component 1140 is capable of, configured to, or operable to support a means for outputting downlink control information indicative of the modulation order backoff value from the set of modulation order backoff values.

In some examples, the control signaling is indicative of a subset of ports of a set of multiple ports to use for communication of the set of multiple data-carrying reference signals. In some examples, the set of multiple data-carrying reference signals are communicated via the subset of ports that is different from one or more ports used for communication of the shared data channel.

In some examples, to support outputting the control signaling, the DCI output component 1140 is capable of, configured to, or operable to support a means for outputting downlink control information message that is indicative of the subset of ports.

In some examples, to support outputting the control signaling, the bitmap output component 1145 is capable of, configured to, or operable to support a means for outputting a bitmap indicative of the subset of ports, where each value of the bitmap is associated with a respective DMRS port configured for communication of the shared data channel.

In some examples, to support outputting the control signaling, the DMRS indication output component 1150 is capable of, configured to, or operable to support a means for outputting an indication of a subset of demodulation reference signal ports to use for communication of the shared data channel and where the subset of ports to use for communication of the set of multiple data-carrying reference signals corresponds to the subset of demodulation reference signal ports.

In some examples, to support outputting the control signaling, the index indication output component 1155 is capable of, configured to, or operable to support a means for outputting an indication of an index that is mapped to the subset of ports via a table that maps a set of multiple indexes to respective subsets of ports.

In some examples, the control signaling is indicative of a pattern of the first subset of resource elements within the set of multiple resource elements allocated for communication of the shared data channel.

In some examples, the pattern is indicated via a cell identifier associated with a tone offset, a symbol offset, a random tone offset at different symbols, or a combination thereof.

In some examples, the control signaling is indicative of a respective configuration per covariance matrix estimation window of two or more covariance matrix estimation windows.

In some examples, the configuration further specifies a first modulation order used for encoding the set of multiple data-carrying reference signals, the first modulation order being a same modulation order as a second modulation order used for encoding data of the shared data channel separate from the set of multiple data-carrying reference signals or being a smaller modulation order than the second modulation order.

In some examples, the configuration further specifies a first quantity of layers to be used for communication of the set of multiple data-carrying reference signals, the first quantity of layers being equal to or less than a second quantity of layers used for communication of the shared data channel separate from the set of multiple data-carrying reference signals.

In some examples, the configuration further specifies a set of multiple ports associated with the set of multiple data-carrying reference signals, the set of multiple ports being at least partially located at a location of a set of multiple ports associated with demodulated reference signals of the shared data channel. In some examples, communicating the data is based on the set of multiple ports.

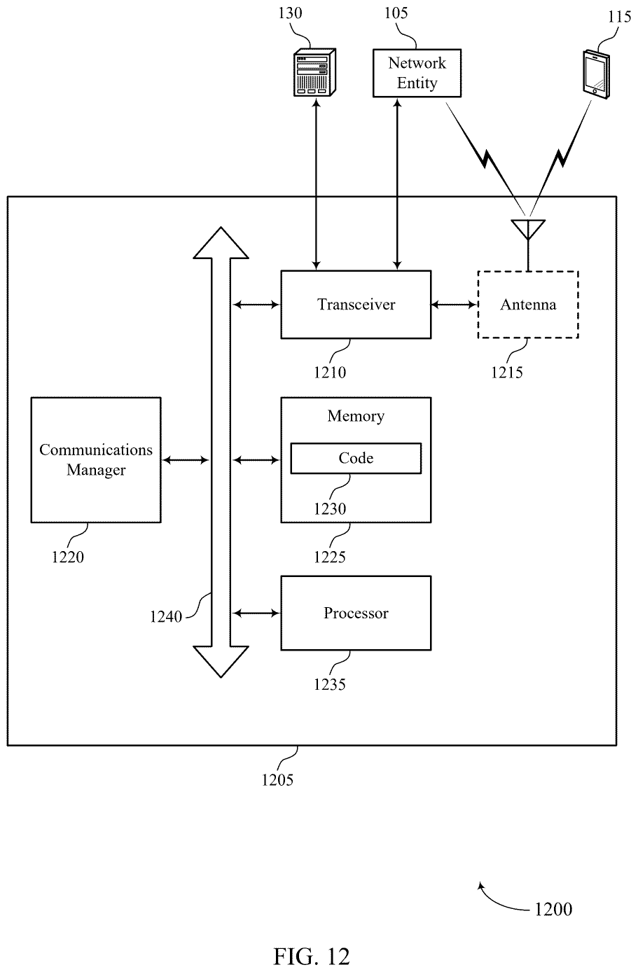

FIG. 12 shows a diagram of a system 1200 including a device 1205 that supports configurations for data-carrying reference signals in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more GPUs, one or more NPUs (also referred to as neural network processors or (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting configurations for data-carrying reference signals). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The communications manager 1220 is capable of, configured to, or operable to support a means for communicating the data allocated to the shared data channel via the set of multiple resource elements of the shared data channel, the data including the first portion encoded in the set of multiple data-carrying reference signals and a second portion encoded in a second subset of resource elements of the set of multiple resource elements.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of configurations for data-carrying reference signals as described herein, or the at least one processor 1235 and the at least one memory 1225 may be otherwise configured to, individually or collectively, perform or support such operations.

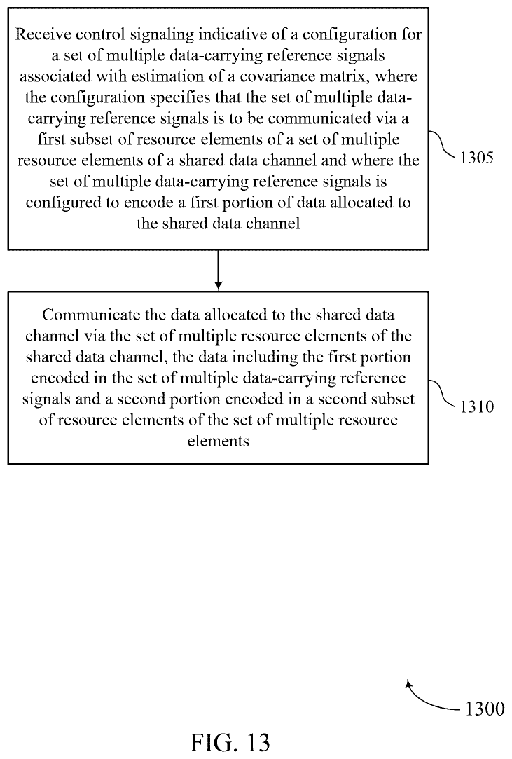

FIG. 13 shows a flowchart illustrating a method 1300 that supports configurations for data-carrying reference signals in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The operations of 1305 may be performed in accordance with examples as disclosed herein. In some examples, aspects of the operations of 1305 may be performed by a control signaling reception component 725 as described with reference to FIG. 7.

At 1310, the method may include communicating the data allocated to the shared data channel via the set of multiple resource elements of the shared data channel, the data including the first portion encoded in the set of multiple data-carrying reference signals and a second portion encoded in a second subset of resource elements of the set of multiple resource elements. The operations of 1310 may be performed in accordance with examples as disclosed herein. In some examples, aspects of the operations of 1310 may be performed by a data communication component 730 as described with reference to FIG. 7.

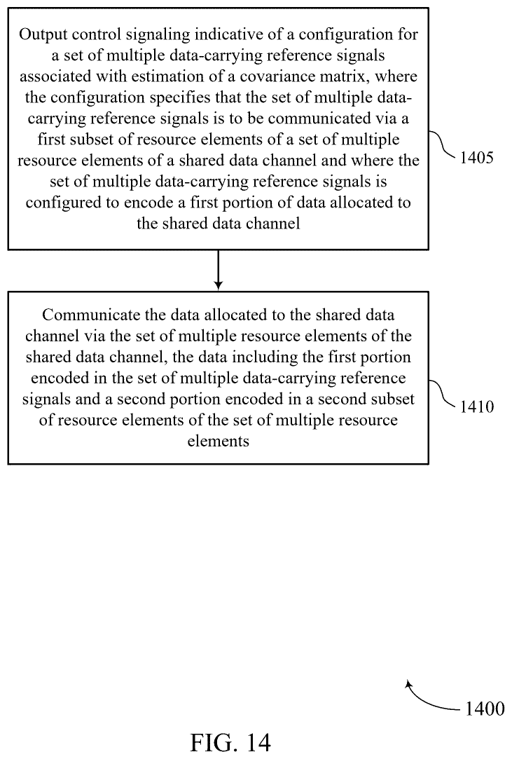

FIG. 14 shows a flowchart illustrating a method 1400 that supports configurations for data-carrying reference signals in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting control signaling indicative of a configuration for a set of multiple data-carrying reference signals associated with estimation of a covariance matrix, where the configuration specifies that the set of multiple data-carrying reference signals is to be communicated via a first subset of resource elements of a set of multiple resource elements of a shared data channel and where the set of multiple data-carrying reference signals is configured to encode a first portion of data allocated to the shared data channel. The operations of 1405 may be performed in accordance with examples as disclosed herein. In some examples, aspects of the operations of 1405 may be performed by a control signaling output component 1125 as described with reference to FIG. 11.

At 1410, the method may include communicating the data allocated to the shared data channel via the set of multiple resource elements of the shared data channel, the data including the first portion encoded in the set of multiple data-carrying reference signals and a second portion encoded in a second subset of resource elements of the set of multiple resource elements. The operations of 1410 may be performed in accordance with examples as disclosed herein. In some examples, aspects of the operations of 1410 may be performed by a data communication component 1130 as described with reference to FIG. 11.

The following provides an overview of aspects of the present disclosure:

Aspect 1: A method for wireless communications at a UE, comprising: receiving control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and communicating the data allocated to the shared data channel via the plurality of resource elements of the shared data channel, the data comprising the first portion encoded in the plurality of data-carrying reference signals and a second portion encoded in a second subset of resource elements of the plurality of resource elements.

Aspect 2: The method of aspect 1, wherein the control signaling is indicative of a layer quantity backoff value for communication of the plurality of data-carrying reference signals, the plurality of data-carrying reference signals are communicated via the first subset of resource elements using a second quantity of layers that is based at least in part on the layer quantity backoff value and a first quantity of layers configured for communication of the shared data channel.

Aspect 3: The method of aspect 2, wherein receiving the control signaling comprises: receiving radio resource control signaling that is indicative of the layer quantity backoff value.

Aspect 4: The method of any of aspects 2 through 3, wherein receiving the control signaling comprises: receiving downlink control information that is indicative of the layer quantity backoff value and that schedules communication of the shared data channel.

Aspect 5: The method of any of aspects 1 through 4, wherein the control signaling is indicative of a modulation order backoff value for communication of the plurality of data-carrying reference signals, the plurality of data-carrying reference signals are communicated via the first subset of resource elements and encoded using a second modulator order that is based at least in part on the modulation order backoff value and a first modulation order configured for communication of the shared data channel.

Aspect 6: The method of aspect 5, wherein receiving the control signaling comprises: receiving radio resource control signaling that is indicative of the modulation order backoff value.

Aspect 7: The method of any of aspects 5 through 6, wherein receiving the control signaling comprises: receiving downlink control information that is indicative of the modulation order backoff value and that schedules communication of the shared data channel.

Aspect 8: The method of aspect 7, wherein the modulation order backoff value is to be applied to a first covariance matrix estimation window and a second covariance matrix estimation window.

Aspect 9: The method of any of aspects 7 through 8, wherein the downlink control information indicates the modulation order backoff value that is a first modulation order backoff value to be applied for a first covariance matrix estimation window and the downlink control information indicates a second modulation order backoff value to be applied for a second covariance matrix estimation window.

Aspect 10: The method of any of aspects 5 through 9, wherein receiving the control signaling comprises: receiving radio resource control signaling comprising a set of modulation order backoff values; and receiving downlink control information indicative of the modulation order backoff value from the set of modulation order backoff values.

Aspect 11: The method of any of aspects 1 through 10, wherein the control signaling is indicative of a subset of ports of a plurality of ports to use for transmission of the plurality of data-carrying reference signals, the plurality of data-carrying reference signals are communicated via the subset of ports that is different from one or more ports used for communication of the shared data channel.

Aspect 12: The method of aspect 11, wherein receiving the control signaling comprises: receiving downlink control information message that is indicative of the subset of ports.

Aspect 13: The method of any of aspects 11 through 12, wherein receiving the control signaling comprises: receiving a bitmap indicative of the subset of ports, wherein each value of the bitmap is associated with a respective DMRS port configured for communication of the shared data channel.

Aspect 14: The method of any of aspects 11 through 13, wherein receiving the control signaling comprises: receiving an indication of a subset of demodulation reference signal ports to use for communication of the shared data channel and wherein the subset of ports to use for communication of the plurality of data-carrying reference signals corresponds to the subset of demodulation reference signal ports.

Aspect 15: The method of any of aspects 11 through 14, wherein receiving the control signaling comprises: receiving an indication of an index that is mapped to the subset of ports via a table that maps a plurality of indexes to respective subsets of ports.

Aspect 16: The method of any of aspects 1 through 15, wherein the control signaling is indicative of a pattern of the first subset of resource elements within the plurality of resource elements allocated for communication of the shared data channel.

Aspect 17: The method of aspect 16, wherein the pattern is indicated via a cell identifier associated with a tone offset, a symbol offset, a random tone offset at different symbols, or a combination thereof.

Aspect 18: The method of any of aspects 1 through 17, wherein the control signaling is indicative of a respective configuration per covariance matrix estimation window of two or more covariance matrix estimation windows.

Aspect 19: The method of any of aspects 1 through 18, wherein the configuration further specifies a first modulation order used for encoding the plurality of data-carrying reference signals, the first modulation order being a same modulation order as a second modulation order used for encoding data of the shared data channel separate from the plurality of data-carrying reference signals or being a smaller modulation order than the second modulation order.

Aspect 20: The method of any of aspects 1 through 19, wherein the configuration further specifies a first quantity of layers to be used for communication of the plurality of data-carrying reference signals, the first quantity of layers being equal to or less than a second quantity of layers used for communication of the shared data channel separate from the plurality of data-carrying reference signals.

Aspect 21: The method of any of aspects 1 through 20, wherein the configuration further specifies a plurality of ports associated with the plurality of data-carrying reference signals, the plurality of ports being at least partially located at a location of a plurality of ports associated with demodulated reference signals of the shared data channel, communicating the data is based at least in part on the plurality of ports.

Aspect 22: The method of any of aspects 1 through 21, further comprising: determining a transport block size for the shared data channel based at least in part on a quantity of resource elements of the plurality of resource elements and a modulation order scheduled for communication of the shared data channel.

Aspect 23: The method of any of aspects 1 through 22, further comprising: determining a transport block size for the shared data channel based at least in part on a first quantity of resource elements in the second subset and a first modulation order used for encoding the shared data channel and a second quantity of resource elements in the first subset and a second modulation order used for encoding the plurality of data-carrying reference signals.

Aspect 24: A method for wireless communications at a network entity, comprising: outputting control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and communicating the data allocated to the shared data channel via the plurality of resource elements of the shared data channel, the data comprising the first portion encoded in the plurality of data-carrying reference signals and a second portion encoded in a second subset of resource elements of the plurality of resource elements.

Aspect 25: The method of aspect 24, wherein the control signaling is indicative of a layer quantity backoff value for communication of the plurality of data-carrying reference signals, the plurality of data-carrying reference signals are communicated via the first subset of resource elements using a second quantity of layers that is based at least in part on the layer quantity backoff value and a first quantity of layers configured for communication of the shared data channel.

Aspect 26: The method of aspect 25, wherein outputting the control signaling comprises: outputting radio resource control signaling that is indicative of the layer quantity backoff value.

Aspect 27: The method of any of aspects 25 through 26, wherein outputting the control signaling comprises: outputting downlink control information that is indicative of the layer quantity backoff value and that schedules communication of the shared data channel.

Aspect 28: The method of any of aspects 24 through 27, wherein the control signaling is indicative of a modulation order backoff value for communication of the plurality of data-carrying reference signals, the plurality of data-carrying reference signals are communicated via the first subset of resource elements and encoded using a second modulator order that is based at least in part on the modulation order backoff value and a first modulation order configured for communication of the shared data channel.

Aspect 29: The method of aspect 28, wherein outputting the control signaling comprises: outputting radio resource control signaling that is indicative of the modulation order backoff value.

Aspect 30: The method of any of aspects 28 through 29, wherein outputting the control signaling comprises: outputting downlink control information that is indicative of the modulation order backoff value and that schedules communication of the shared data channel.

Aspect 31: The method of aspect 30, wherein the modulation order backoff value is to be applied to a first covariance matrix estimation window and a second covariance matrix estimation window.

Aspect 32: The method of any of aspects 30 through 31, wherein the downlink control information indicates the modulation order backoff value that is a first modulation order backoff value to be applied for a first covariance matrix estimation window and the downlink control information indicates a second modulation order backoff value to be applied for a second covariance matrix estimation window.

Aspect 33: The method of any of aspects 28 through 32, wherein outputting mitting the control signaling comprises: outputting radio resource control signaling comprising a set of modulation order backoff values; and outputting downlink control information indicative of the modulation order backoff value from the set of modulation order backoff values.

Aspect 34: The method of any of aspects 24 through 33, wherein the control signaling is indicative of a subset of ports of a plurality of ports to use for communication of the plurality of data-carrying reference signals, the plurality of data-carrying reference signals are communicated via the subset of ports that is different from one or more ports used for communication of the shared data channel.

Aspect 35: The method of aspect 34, wherein outputting the control signaling comprises: outputting downlink control information message that is indicative of the subset of ports.

Aspect 36: The method of any of aspects 34 through 35, wherein outputting the control signaling comprises: outputting a bitmap indicative of the subset of ports, wherein each value of the bitmap is associated with a respective DMRS port configured for communication of the shared data channel.

Aspect 37: The method of any of aspects 34 through 36, wherein outputting the control signaling comprises: outputting an indication of a subset of demodulation reference signal ports to use for communication of the shared data channel and wherein the subset of ports to use for communication of the plurality of data-carrying reference signals corresponds to the subset of demodulation reference signal ports.

Aspect 38: The method of any of aspects 34 through 37, wherein outputting the control signaling comprises: outputting an indication of an index that is mapped to the subset of ports via a table that maps a plurality of indexes to respective subsets of ports.

Aspect 39: The method of any of aspects 24 through 38, wherein the control signaling is indicative of a pattern of the first subset of resource elements within the plurality of resource elements allocated for communication of the shared data channel.

Aspect 40: The method of aspect 39, wherein the pattern is indicated via a cell identifier associated with a tone offset, a symbol offset, a random tone offset at different symbols, or a combination thereof.

Aspect 41: The method of any of aspects 24 through 40, wherein the control signaling is indicative of a respective configuration per covariance matrix estimation window of two or more covariance matrix estimation windows.

Aspect 42: The method of any of aspects 24 through 41, wherein the configuration further specifies a first modulation order used for encoding the plurality of data-carrying reference signals, the first modulation order being a same modulation order as a second modulation order used for encoding data of the shared data channel separate from the plurality of data-carrying reference signals or being a smaller modulation order than the second modulation order.

Aspect 43: The method of any of aspects 24 through 42, wherein the configuration further specifies a first quantity of layers to be used for communication of the plurality of data-carrying reference signals, the first quantity of layers being equal to or less than a second quantity of layers used for communication of the shared data channel separate from the plurality of data-carrying reference signals.

Aspect 44: The method of any of aspects 24 through 43, wherein the configuration further specifies a plurality of ports associated with the plurality of data-carrying reference signals, the plurality of ports being at least partially located at a location of a plurality of ports associated with demodulated reference signals of the shared data channel, communicating the data is based at least in part on the plurality of ports.

Aspect 45: A UE for wireless communications, comprising one or more memories storing processor-executable code, and one or more processors coupled with (e.g., operatively, communicatively, functionally, electronically, or electrically) the one or more memories and individually or collectively operable to execute the code to cause the UE to perform a method of any of aspects 1 through 23.

Aspect 46: A UE for wireless communications, comprising at least one means for performing a method of any of aspects 1 through 23.

Aspect 47: A non-transitory computer-readable medium storing code for wireless communications, the code comprising instructions executable by one or more processors (e.g., operatively, communicatively, functionally, electronically, or electrically) to perform a method of any of aspects 1 through 23.

Aspect 48: A network entity for wireless communications, comprising one or more memories storing processor-executable code, and one or more processors coupled with (e.g., operatively, communicatively, functionally, electronically, or electrically) the one or more memories and individually or collectively operable to execute the code to cause the network entity to perform a method of any of aspects 24 through 44.

Aspect 49: A network entity for wireless communications, comprising at least one means for performing a method of any of aspects 24 through 44.

Aspect 50: A non-transitory computer-readable medium storing code for wireless communications, the code comprising instructions executable by one or more processors (e.g., operatively, communicatively, functionally, electronically, or electrically) to perform a method of any of aspects 24 through 44.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and
communicate the data allocated to the shared data channel via the plurality of resource elements of the shared data channel, the data comprising the first portion encoded in the plurality of data-carrying reference signals and a second portion encoded in a second subset of resource elements of the plurality of resource elements.

2. The UE of claim 1, wherein:
the control signaling is indicative of a layer quantity backoff value for communication of the plurality of data-carrying reference signals, and
the plurality of data-carrying reference signals are communicated via the first subset of resource elements using a second quantity of layers that is based at least in part on the layer quantity backoff value and a first quantity of layers configured for communication of the shared data channel.

3. The UE of claim 2, wherein, to receive the control signaling, the one or more processors are individually or collectively operable to execute the code to cause the UE to:
receive radio resource control signaling that is indicative of the layer quantity backoff value.

4. The UE of claim 2, wherein, to receive the control signaling, the one or more processors are individually or collectively operable to execute the code to cause the UE to:
receive downlink control information that is indicative of the layer quantity backoff value and that schedules communication of the shared data channel.

5. The UE of claim 1, wherein:
the control signaling is indicative of a modulation order backoff value for communication of the plurality of data-carrying reference signals, and
the plurality of data-carrying reference signals are communicated via the first subset of resource elements and encoded using a second modulator order that is based at least in part on the modulation order backoff value and a first modulation order configured for communication of the shared data channel.

6. The UE of claim 5, wherein, to receive the control signaling, the one or more processors are individually or collectively operable to execute the code to cause the UE to:
receive radio resource control signaling that is indicative of the modulation order backoff value.

7. The UE of claim 5, wherein, to receive the control signaling, the one or more processors are individually or collectively operable to execute the code to cause the UE to:
receive downlink control information that is indicative of the modulation order backoff value and that schedules communication of the shared data channel.

8. The UE of claim 7, wherein the modulation order backoff value is to be applied to a first covariance matrix estimation window and a second covariance matrix estimation window.

9. The UE of claim 7, wherein the downlink control information indicates the modulation order backoff value that is a first modulation order backoff value to be applied for a first covariance matrix estimation window and the downlink control information indicates a second modulation order backoff value to be applied for a second covariance matrix estimation window.

10. The UE of claim 5, wherein, to receive the control signaling, the one or more processors are individually or collectively operable to execute the code to cause the UE to:
receive radio resource control signaling comprising a set of modulation order backoff values; and
receive downlink control information indicative of the modulation order backoff value from the set of modulation order backoff values.

11. The UE of claim 1, wherein:
the control signaling is indicative of a subset of ports of a plurality of ports to use for transmission of the plurality of data-carrying reference signals, and
the plurality of data-carrying reference signals are communicated via the subset of ports that is different from one or more ports used for communication of the shared data channel.

12. The UE of claim 11, wherein, to receive the control signaling, the one or more processors are individually or collectively operable to execute the code to cause the UE to:
receive downlink control information message that is indicative of the subset of ports.

13. The UE of claim 11, wherein, to receive the control signaling, the one or more processors are individually or collectively operable to execute the code to cause the UE to:
receive a bitmap indicative of the subset of ports, wherein each value of the bitmap is associated with a respective DMRS port configured for communication of the shared data channel.

14. The UE of claim 11, wherein, to receive the control signaling, the one or more processors are individually or collectively operable to execute the code to cause the UE to:
receive an indication of a subset of demodulation reference signal ports to use for communication of the shared data channel and wherein the subset of ports to use for communication of the plurality of data-carrying reference signals corresponds to the subset of demodulation reference signal ports.

15. The UE of claim 11, wherein, to receive the control signaling, the one or more processors are individually or collectively operable to execute the code to cause the UE to:
receive an indication of an index that is mapped to the subset of ports via a table that maps a plurality of indexes to respective subsets of ports.

16. The UE of claim 1, wherein the control signaling is indicative of a pattern of the first subset of resource elements within the plurality of resource elements allocated for communication of the shared data channel.

17. The UE of claim 16, wherein the pattern is indicated via a cell identifier associated with a tone offset, a symbol offset, a random tone offset at different symbols, or a combination thereof.

18. The UE of claim 1, wherein the control signaling is indicative of a respective configuration per covariance matrix estimation window of two or more covariance matrix estimation windows.

19. The UE of claim 1, wherein the configuration further specifies a first modulation order used for encoding the plurality of data-carrying reference signals, the first modulation order being a same modulation order as a second modulation order used for encoding data of the shared data channel separate from the plurality of data-carrying reference signals or being a smaller modulation order than the second modulation order.

20. The UE of claim 1, wherein the configuration further specifies a first quantity of layers to be used for communication of the plurality of data-carrying reference signals, the first quantity of layers being equal to or less than a second quantity of layers used for communication of the shared data channel separate from the plurality of data-carrying reference signals.

21. The UE of claim 1, wherein:
the configuration further specifies a plurality of ports associated with the plurality of data-carrying reference signals, the plurality of ports being at least partially located at a location of a plurality of ports associated with demodulated reference signals of the shared data channel, and one or more processors are individually or collectively further operable to execute the code to cause the UE to:
communicate the data is based at least in part on the plurality of ports.

22. The UE of claim 1, wherein the one or more processors are individually or collectively further operable to execute the code to cause the UE to:
determine a transport block size for the shared data channel based at least in part on a quantity of resource elements of the plurality of resource elements and a modulation order scheduled for communication of the shared data channel.

23. The UE of claim 1, wherein the one or more processors are individually or collectively further operable to execute the code to cause the UE to:
determine a transport block size for the shared data channel based at least in part on a first quantity of resource elements in the second subset and a first modulation order used for encoding the shared data channel and a second quantity of resource elements in the first subset and a second modulation order used for encoding the plurality of data-carrying reference signals.

24. A network entity, comprising:
one or more memories storing processor-executable code; and
one or more processors coupled with the one or more memories and individually or collectively operable to execute the code to cause the network entity to:
output control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and
communicate the data allocated to the shared data channel via the plurality of resource elements of the shared data channel, the data comprising the first portion encoded in the plurality of data-carrying reference signals and a second portion encoded in a second subset of resource elements of the plurality of resource elements.

25. The network entity of claim 24, wherein:
the control signaling is indicative of a layer quantity backoff value for communication of the plurality of data-carrying reference signals, and
the plurality of data-carrying reference signals are communicated via the first subset of resource elements using a second quantity of layers that is based at least in part on the layer quantity backoff value and a first quantity of layers configured for communication of the shared data channel.

26. The network entity of claim 25, wherein, to output the control signaling, the one or more processors are individually or collectively operable to execute the code to cause the network entity to:
output radio resource control signaling that is indicative of the layer quantity backoff value.

27. The network entity of claim 25, wherein, to output the control signaling, the one or more processors are individually or collectively operable to execute the code to cause the network entity to:
output downlink control information that is indicative of the layer quantity backoff value and that schedules communication of the shared data channel.

28. The network entity of claim 24, wherein:
the control signaling is indicative of a modulation order backoff value for communication of the plurality of data-carrying reference signals, and
the plurality of data-carrying reference signals are communicated via the first subset of resource elements and encoded using a second modulator order that is based at least in part on the modulation order backoff value and a first modulation order configured for communication of the shared data channel.

29. A method for wireless communications at a user equipment (UE), comprising:
receiving control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and
communicating the data allocated to the shared data channel via the plurality of resource elements of the shared data channel, the data comprising the first portion encoded in the plurality of data-carrying reference signals and a second portion encoded in a second subset of resource elements of the plurality of resource elements.

30. A method for wireless communications at a network entity, comprising:
outputting control signaling indicative of a configuration for a plurality of data-carrying reference signals associated with estimation of a covariance matrix, wherein the configuration specifies that the plurality of data-carrying reference signals is to be communicated via a first subset of resource elements of a plurality of resource elements of a shared data channel and wherein the plurality of data-carrying reference signals is configured to encode a first portion of data allocated to the shared data channel; and
communicating the data allocated to the shared data channel via the plurality of resource elements of the shared data channel, the data comprising the first portion encoded in the plurality of data-carrying reference signals and a second portion encoded in a second subset of resource elements of the plurality of resource elements.
